(19) United States
(12) Patent Application Publication
(10) Pub. No.: US 2024/0023600 A1
(43) Pub. Date: Jan. 25, 2024

(54) HEAT-NOT-BURN FLAVOR INHALATION ARTICLE AND HEAT-NOT-BURN FLAVOR INHALATION PRODUCT

(71) Applicant: JAPAN TOBACCO INC., Tokyo (JP)

(72) Inventors: Reijiro KAWASAKI, Tokyo (JP); Shota YAMAGUCHI, Tokyo (JP); Hiroshi SHIBUICHI, Tokyo (JP)

(73) Assignee: JAPAN TOBACCO INC., Tokyo (JP)

(21) Appl. No.: 18/478,550

(22) Filed: Sep. 29, 2023

Related U.S. Application Data
(63) Continuation of application No. PCT/JP2022/016008, filed on Mar. 30, 2022.

(30) Foreign Application Priority Data
Mar. 31, 2021 (WO) PCT/JP2021/014097
Mar. 31, 2021 (WO) PCT/JP2021/014098

(51) Int. Cl. A24D 1/20; A24D 1/02; A24D 1/04; A24D 3/10; A24F 40/20; A24F 40/465

(52) U.S. Cl. CPC A24D 1/20; A24D 1/02; A24D 1/045; A24D 3/10; A24F 40/20; A24F 40/465

(57) ABSTRACT

Provided is a heat-not-burn flavor inhalation article that is to be used with an electric heating device that comprises an inductor for electromagnetic induction heating. The heat-not-burn flavor inhalation article comprises: a flavor generation segment filler that includes an aerosol base material; a flavor generation segment that includes a plate-shaped susceptor for electromagnetic induction heating the flavor generation segment filler; and a mouthpiece segment for inhaling a flavor component. The compressive change rate of the flavor generation segment and the mouthpiece segment as measured in accordance with a specific compressive change rate measurement method by pressing an airflow-direction center part of each segment is at least 70%.

### CROSS REFERENCES TO RELATED APPLICATIONS

This application is a Continuation of PCT International Application No. PCT/JP2022/016008, filed on Mar. 30, 2022, which is claiming priority from PCT International Application No. PCT/JP2021/014097, filed on Mar. 31, 2021 and PCT International Application No. PCT/JP2021/014098, filed on Mar. 31, 2021, and the entire contents of which are incorporated herein by reference.

### TECHNICAL FIELD

The present invention relates to a non-combustion-heating-type flavor inhalation article and a non-combustion-heating-type flavor inhalation product.

### BACKGROUND ART

In the related art, there has been proposed an aerosol generating device including a heating element, such as a susceptor, and a porous medium that is filled with a gel containing an aerosol forming material (e.g., Patent Document 1 to Patent Document 6).

### CITATION LIST

Patent Document
Patent Document 1: International Publication No. 2020/127116
Patent Document 2: International Publication No. 2020/025562
Patent Document 3: International Publication No. 2019/197170
Patent Document 4: International Publication No. 2020/216762
Patent Document 5: International Publication No. 2020/216765
Patent Document 6: International Publication No. 2020/249661

### SUMMARY OF INVENTION

### Technical Problem

It is an object of the present invention to improve the performance of a non-combustion-heating-type flavor inhalation product.

### Solution to Problem

The gist of the present invention is as follows.
[1] A non-combustion-heating-type flavor inhalation article used with an electrical heating type device comprising an inductor for electromagnetic induction heating, the non-combustion-heating-type flavor inhalation article comprising:
   a flavor-generating segment that includes a flavor-generating-segment filler containing an aerosol-source material and a plate-shaped susceptor for electromagnetic induction heating of the flavor-generating-segment filler and
   a mouthpiece segment for inhaling a flavor component,
   wherein a compression change rate of each of the segments, as measured by pressing each airflow-direction central part of the flavor-generating segment and the mouthpiece segment in accordance with a compression change rate measurement method below, is 70% or greater, where
   compression change rate measurement method: a load F of 2 kgf is applied to 10 samples simultaneously, the 10 samples being arranged side by side in a horizontal direction, from an upper side to a lower side by using a measuring instrument DD60A manufactured by Borgwaldt Co., Ltd.; after the load F has been applied for 5 seconds, an average of diameters of rod portions is measured; a compression change rate (%) is expressed by a formula below;

compression change rate (%)=100×(Dd (diameter after deformation))/(Ds (diameter before deformation))
where Dd stands for the diameter of each of the rod portions that has been reduced as a result of the load F being applied to the rod portion, and Ds stands for the diameter of each of the rod portions before the load F is applied; in the method, measurement is performed 10 times for each set of 10 samples (100 samples in total), and an average value of results of the measurement performed 10 times is used as a measurement result.
[2] The non-combustion-heating-type flavor inhalation article according to [1],
   wherein the mouthpiece segment comprises a cooling segment and a filter segment, and the cooling segment is positioned upstream from the filter segment,
   wherein the flavor-generating-segment filler contains at least one selected from tobacco leaves, shredded tobacco, a tobacco sheet, tobacco granules, a nicotine-carrying ion-exchange resin, and a tobacco extract.
[3] The non-combustion-heating-type flavor inhalation article according to [2],
   wherein the flavor-generating-segment filler comprises a tobacco sheet, and the tobacco sheet is inserted in a gathered manner after being crimped.
[4] The non-combustion-heating-type flavor inhalation article according to any one of [1] to [3],
   wherein a filling density of the flavor-generating-segment filler in the flavor-generating segment is 0.2 g/cm³ to 0.7 g/cm³.
[5] The non-combustion-heating-type flavor inhalation article according to any one of [1] to [4],
   wherein the mouthpiece segment further comprises a filter segment, and the filter segment comprises a filter element and wrapping paper wrapping the filter element, the wrapping paper having a thickness of 40 μm to 100 μm, and a basis weight of 23 gsm to 90 gsm.
[6] The non-combustion-heating-type flavor inhalation article according to any one of [1] to [4],
   wherein the mouthpiece segment comprises a cooling segment and a filter segment.
[7] The non-combustion-heating-type flavor inhalation article according to [5] or [6],
   wherein the non-combustion-heating-type flavor inhalation article further comprises an end segment and a support segment, and the end segment, the support segment, and the filter segment contain cellulose acetate fibers.
[8] The non-combustion-heating-type flavor inhalation article according to [7],
   wherein the end segment, the support segment, and the filter segment are each a solidified member containing cellulose acetate fibers and a plasticizer.
[9] A non-combustion-heating-type flavor inhalation product, the non-combustion-heating-type flavor inhalation product comprising:
   the non-combustion-heating-type flavor inhalation article according to any one of [1] to [8] and
an electrical heating type device,
wherein the electrical heating type device comprises
   an inductor for electromagnetic induction heating,
   a power source that supplies operation power to the inductor,
   a control unit for controlling the inductor, and
   a heating chamber into which the non-combustion-heating-type flavor inhalation article can be inserted via an insertion slot.

Note that the contents described in Solution to Problem can be combined to the fullest extent possible without departing from the problem and the technical idea of the present invention.

### Advantageous Effects of Invention

According to the present invention, the performance of a non-combustion-heating-type flavor inhalation product can be improved.

### BRIEF DESCRIPTION OF DRAWINGS

FIG. 1 is a diagram schematically illustrating a configuration of a non-combustion-heating-type flavor inhalation product according to the present embodiment.

FIG. 2 is a diagram schematically illustrating the configuration of the non-combustion-heating-type flavor inhalation product according to the present embodiment.

FIG. 3 is a diagram illustrating an example of a non-combustion-heating-type tobacco.

FIG. 4 is a perspective view illustrating an example of a plate-shaped susceptor.

FIG. 5 is a diagram schematically illustrating a method of manufacturing the plate-shaped susceptor.

FIG. 6 is a plan view depicting a modification of the plate-shaped susceptor.

FIG. 7 is a plan view depicting another modification of the plate-shaped susceptor.

FIG. 8 is a diagram depicting a cut surface of the plate-shaped susceptor.

FIG. 9 is a diagram depicting a modification of a flavor-generating segment.

FIG. 10 is a diagram depicting a method of manufacturing the plate-shaped susceptor that has been coated.

FIG. 11 is a diagram depicting a modification of a coating layer.

FIG. 12 is a diagram depicting another modification of the coating layer.

FIG. 13 is a diagram depicting another modification of the coating layer.

FIG. 14 is a diagram depicting a modification of the non-combustion-heating-type tobacco.

FIG. 15 is an example of a longitudinal sectional view obtained by cutting the non-combustion-heating-type tobacco along a width direction of the plate-shaped susceptor.

FIG. 16 is a diagram depicting a modification of a lining sheet.

FIG. 17 is a diagram depicting a gluing pattern of the lining sheet.

FIG. 18 is a diagram depicting another modification of a lining sheet.

### DESCRIPTION OF EMBODIMENTS

An embodiment of a non-combustion-heating-type tobacco according to the present invention will be described with reference to the drawings. The dimensions, the materials, the shapes, the relative arrangement, and so forth of the components described in the present embodiment are examples. In addition, the order of steps is an example and can be changed, or the processes can be performed in parallel as long as they do not depart from the problem and the technical idea of the present invention. Thus, the technical scope of the invention is not limited to the following examples unless otherwise specified.

Note that, in the present specification, when numerical values or physical property values are mentioned before and after an expression “to”, it implies that the range includes the values mentioned before and after “to”.

### <Non-Combustion-Heating-Type Flavor Inhalation Product>

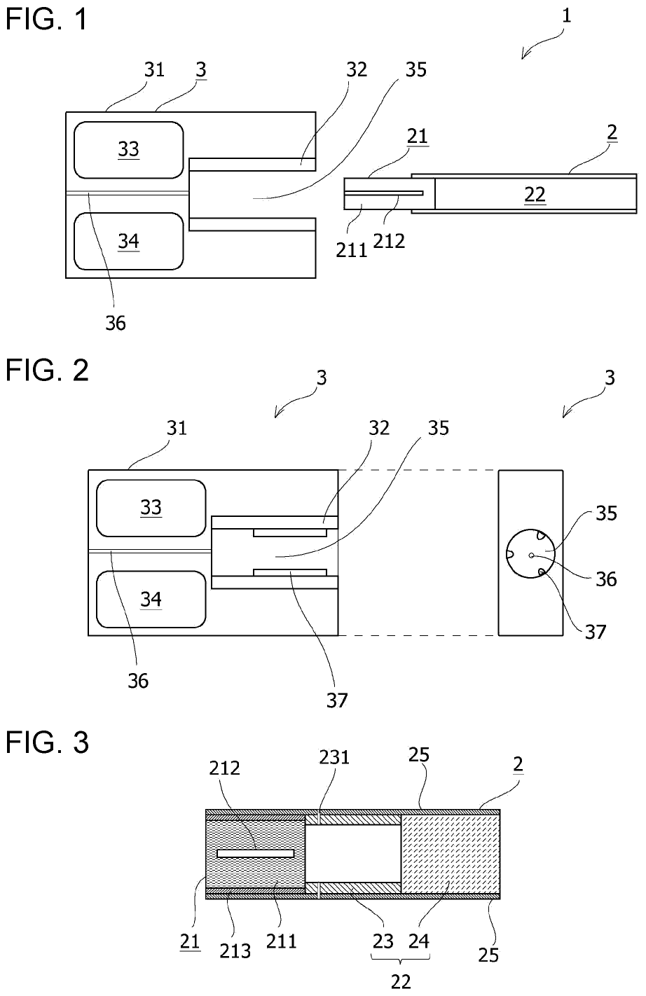

FIG. 1 is a diagram schematically illustrating an example of the configuration of a non-combustion-heating-type flavor inhalation product according to the present embodiment. A non-combustion-heating-type flavor inhalation product 1 according to the present embodiment includes a non-combustion-heating-type tobacco (non-combustion-heating-type flavor inhalation article) 2 and an electrical heating type device 3 that heats a flavor-generating segment 21 of the non-combustion-heating-type tobacco 2 by electromagnetic induction heating.

The electrical heating type device 3 includes a body 31, an inductor for electromagnetic induction heating 32, a battery unit (a power source) 33 that supplies operation power to the inductor 32 so as to cause the inductor 32 to operate, and a control unit 34 that controls the inductor. The body 31 has a tubular cavity 35 and an airflow path 36, the air flow path 36 extending through the body 31 from a bottom surface of the cavity 35, which is the bottommost portion (i.e., the deepest portion) of the cavity 35, to an outer surface of an airflow-direction end portion of the body 31, and the inductor 32 is disposed on an inner side surface of the cavity 35 so as to be located at a position corresponding to the flavor-generating segment of the non-combustion-heating-type tobacco 2 inserted into the cavity 35. More specifically, the cavity 35 is a heating chamber into which the non-combustion-heating-type flavor inhalation article can be inserted via an insertion slot. Note that, although the airflow path 36 in the electrical heating device 3 in FIG. 1 is a through hole linearly extending between the bottom surface of the cavity 35 and the outer surface of an airflow-direction end portion of the body 31, the shape of the airflow path 36 is not particularly limited as long as it extends through the body 31 from the bottom surface of the cavity 35 to the outer surface of the body 31. For example, the airflow path 36 may have an L shape and extend between the bottom surface of the cavity 35 to a side surface end portion of the body 31. A manual operation of an operation switch or the like provided on the body 31 may be a trigger for causing the electrical heating type device 3 to operate. Alternatively, the electrical heating type device 3 may be automatically activated in response to a user inserting the non-combustion-heating-type tobacco 2 into the cavity 35 of the electrical heating type device 3. Alternatively, airflow resistance may be generated by engaging an end of the non-combustion-heating-type tobacco opposite to an inhalation port of the non-combustion-heating-type tobacco with a portion of the cavity 35 against which the end abuts may be engaged.

The battery unit 33 supplies a DC current. The control unit 33 includes a DC/AC inverter for supplying a high-frequency AC current to the inductor 32. When the device operates, a high-frequency alternating current passes through a dielectric coil that forms a portion of the inductor 32. As a result, the inductor 32 generates a fluctuating electromagnetic field. The frequency of the electromagnetic field fluctuates by 1-30 MHz, inclusive, preferably 2-10 MHz, inclusive, and more preferably, for example, 5-7 MHz, inclusive.

The non-combustion-heating-type tobacco 2 is designed so as to operate in synchronization with the use of the electrical heating type device 3 that electrically operates. The non-combustion-heating-type tobacco 2 includes a susceptor having a plate-like shape (a plate-shaped susceptor) 212 in the flavor-generating segment 21 containing fillers (flavor-generating-segment fillers) 211, and the plate-shaped susceptor 212 heats the fillers 211 or the like by electromagnetic induction. The fillers 211 are, for example, shredded tobacco including an aerosol-source material. The plate-shaped susceptor 212 is made of a material, such as a metal, for converting electromagnetic energy into heat.

When the non-combustion-heating-type flavor inhalation product 1 is used, a user inserts the non-combustion-heating-type tobacco 2 into the electrical heating type device 3 such that a portion including the plate-shaped susceptor 212 is positioned close to the inductor 32. The inductor 32 is disposed around the cavity 35 of the electrical heating type device 3. When the non-combustion-heating-type tobacco 2 is inserted into the cavity 35 of the electrical heating type device 3, the plate-shaped susceptor 212 of the non-combustion-heating-type tobacco 2 is positioned in the fluctuating electromagnetic field generated by the inductor 32. Then, the fluctuating electromagnetic field generates an eddy current in the plate-shaped susceptor 212, and as a result, the plate-shaped susceptor 212 is heated. Further heating is provided by magnetic hysteresis loss in the plate-shaped susceptor 212.

Subsequently, the plate-shaped susceptor 212, which has been heated, heats the fillers 211 of the non-combustion-heating-type tobacco 2 to a temperature sufficient to form an aerosol. In this case, the temperature to which the fillers 211 are heated may be, for example, 250-400° C., inclusive. Although not particularly limited, a heating temperature by an electrical heating type tobacco product is preferably 400° C. or lower, more preferably 150-400° C., inclusive, and further preferably 200-350° C., inclusive. The aerosol generated by heating passes through a mouthpiece segment 22 and is inhaled by the user.

The shape of the cavity 35 of the electrical heating type device 3 is not particularly limited as long as the non-combustion-heating-type tobacco 2 can be inserted into the cavity 35 and may be, for example, a cylindrical shape or a polygonal columnar shape such as a quadrangular prism or a pentagonal prism. However, considering the holding stability of the non-combustion-heating-type tobacco 2, it is preferable that the cavity 35 have a cylindrical shape. In the case where the shape of the cavity 35 is a cylindrical shape, the diameter of the cylindrical shape can be suitably selected in accordance with the size of the non-combustion-heating-type tobacco 2. However, the diameter is, for example, 5.5-8.0 mm, inclusive, preferably 6.0-7.7 mm, inclusive, and more preferably 6.5-7.2 mm, inclusive. In the case where the shape of the cavity 35 and the shape of the non-combustion-heating-type tobacco 2 are both a cylindrical shape, it is preferable that the diameter of the cavity be equal to or larger than a value obtained by subtracting 0.5 mm from the diameter of the non-combustion-heating-type tobacco 2 and equal to or smaller than the diameter of the non-combustion-heating-type tobacco 2. By setting the diameter of the cavity within this range, the holding stability of the non-combustion-heating-type tobacco 2 can be improved, and in addition, the gap between the cavity 35 and the non-combustion-heating-type tobacco 2 can be reduced, so that a desired airflow resistance can be obtained.

As illustrated in FIG. 2, protrusions 37 for securing the non-combustion-heating-type tobacco 2 may be provided on side walls (the inductor 32 in FIGS. 1 and 2) forming the cavity 35. Although the height of each of the protrusions 37 from their respective side walls forming the cavity 35 is not particularly limited, from the standpoint of the holding stability of the non-combustion-heating-type tobacco 2, the height is, for example, 0.3-2.0 mm, inclusive, preferably 0.5-1.5 mm, inclusive, and more preferably, 0.5-1.0 mm, inclusive. In the case where the shape of the cavity 35 and the shape of the non-combustion-heating-type tobacco 2 are both a cylindrical shape, it is preferable that the diameter of the bottom surface of the cavity be equal to or larger than a value obtained by adding 0.5 mm to the diameter of the non-combustion-heating-type tobacco 2 and equal to or smaller than a value obtained by adding 1.5 mm to the diameter of the non-combustion-heating-type tobacco 2 from the standpoint of the holding stability of the non-combustion-heating-type tobacco 2. By setting the diameter of the bottom surface of the cavity within this range, the holding stability of the non-combustion-heating-type tobacco 2 can be improved, and in addition, a predetermined gap can be formed between the cavity 35 and the non-combustion-heating-type tobacco 2 can be reduced, so that unintentional deformation of the non-combustion-heating-type tobacco 2 can be prevented. In addition, the cross-sectional area of the non-combustion-heating-type tobacco 2 can be changed by the protrusions 37, and thus, a desired airflow resistance can be obtained.

### <Non-Combustion-Heating-Type Tobacco (Non-Combustion-Heating-Type Flavor Inhalation Article)>

FIG. 3 is a diagram illustrating an example of a non-combustion-heating-type tobacco (a non-combustion-heating-type flavor inhalation article). The non-combustion-heating-type tobacco 2 is a non-combustion-heating-type tobacco that is used together with an electrical heating type device provided with an inductor for electromagnetic induction heating and includes a flavor-generating segment 21 and the mouthpiece segment 22. The mouthpiece segment 22 is a member for inhaling a flavor component and includes a cooling segment 23 and a filter segment 24. The flavor-generating segment 21, the cooling segment 23, and the filter segment 24 are arranged in such a manner as to be continuous with one another in a predetermined direction and wrapped with a lining sheet 25. A direction in which the aerosol generated in the flavor-generating segment 21 passes through the mouthpiece segment 22 and is inhaled by a user will be referred to as an airflow direction. The non-combustion-heating-type tobacco 2 has a rod-like shape, particularly a cylindrical shape, and the longitudinal direction of the non-combustion-heating-type tobacco 2 matches the airflow direction.

The length of the non-combustion-heating-type tobacco in the airflow direction is not particularly limited and is normally, for example, 30 mm or greater, preferably 40 mm or greater, and more preferably 45 mm or greater. In addition, the length of the non-combustion-heating-type tobacco in the airflow direction is normally 100 mm or less, preferably 85 mm or less, and more preferably 55 mm or less. The width of the bottom surface of the non-combustion-heating-type tobacco having a cylindrical shape is not particularly limited and is normally, for example, 5.5 mm or more and preferably 6.8 mm or more. In addition, the width of the bottom surface of the non-combustion-heating-type tobacco is normally 8.0 mm or less and preferably 7.2 mm or less.

The airflow resistance of each non-combustion-heating-type tobacco is, for example, 20-110 mmH₂O, inclusive, preferably 20-80 mmH₂O, inclusive, and more preferably 40-70 mmH₂O, inclusive. Within such a range, an appropriate inhaling sensation can be provided to a user.

When a non-combustion heating tobacco is inserted into a cavity (35) of an electrical heating type device, the non-combustion heating tobacco may sometimes become compressed due to the engagement relationship between the shape of the cavity and the outer circumferential shape of the non-combustion-heating-type tobacco, or when the non-combustion heating tobacco is inserted so as to reach an abutment position of the cavity, an end surface of the non-combustion heating tobacco engages with an abutment portion of the cavity, and thus, the airflow resistance of the non-combustion heating tobacco during use, that is, when the non-combustion heating tobacco is inserted into the cavity of the electrical heating type device, may sometimes be increased by 10 mmH₂O to 20 mmH₂O from the airflow resistance in the above state in which the non-combustion heating tobacco is not inserted into the cavity. By designing the airflow resistance of the non-combustion heating tobacco such that, when the non-combustion heating tobacco is inserted into the cavity, the airflow resistance is, for example, 20-110 mmH₂O, inclusive, preferably 20-80 mmH₂O, inclusive, and more preferably 40-70 mmH₂O, inclusive, an appropriate inhaling sensation can be provided to a user.

The airflow resistance of each non-combustion-heating-type tobacco is measured in conformity with an ISO standard method (ISO6565:2015) by using, for example, an NCQA (manufactured by JT tohsi Co., Ltd.). The airflow resistance is the difference between the air pressure (a negative pressure) at a mouthpiece end surface of a non-combustion-heating-type tobacco and the atmosphere when air is inhaled from the mouthpiece end surface of the non-combustion-heating-type tobacco at a predetermined air flow rate (17.5 cc/sec). When the air is inhaled from the mouthpiece end surface, the atmosphere is introduced into the non-combustion heating tobacco from an end portion or a side surface of the non-combustion-heating-type tobacco.

The airflow resistance of each segment is measured in conformity with an ISO standard method (ISO6565:2015) by using, for example, an airflow resistance measuring instrument (product name: SODIMAX, manufactured by SODIM). The airflow resistance of each segment refers to the difference in air pressure between a first end surface and a second end surface when air is passed from one end surface (the first end surface, that is, one of the bottom surfaces of a cylindrical shape) to the other surface (the second end surface, that is, the bottom surface of the cylindrical shape opposite to the first end surface) at a predetermined air flow rate (17.5 cc/sec) in a state where the air does not pass through the side surfaces of each segment (side surfaces of the cylindrical shape) with respect to the airflow direction. The airflow resistance is typically expressed in units of mmH₂O.

In addition, the compression change rate of each segment, as measured by pressing an airflow-direction central part of the non-combustion heating tobacco and/or each segment using the Borgwaldt method is one of the indices indicating hardness and is not particularly limited. However, the compression change rate is, for example, 70% or greater, preferably 80% or greater, and more preferably, 85% or greater. The upper limit is, for example, 95% or less. By setting such a range, for example, a non-combustion-heating-type flavor inhalation article can be smoothly inserted into an electrical heating type device and can be prevented from becoming greatly deformed or damaged at the time of its insertion or removal.

The Borgwaldt method has been widely used for evaluating the hardness qualities of tobacco-filled rod parts and filter parts of tobacco products. For example, a load F of 2 kgf is applied to 10 samples at the same time, the 10 samples being arranged side by side in the horizontal direction, from the upper side to the lower side by using a measuring instrument DD60A manufactured by Borgwaldt Co., Ltd. After the load F has been applied for 5 seconds, the average of the diameters of rod portions is measured. The compression change rate (%) is expressed by the following formula.

compression change rate (%)=100×(Dd (diameter after deformation))/(Ds (diameter before deformation))

In the above formula, Dd stands for the diameter of the rod portion reduced by receiving the load F, and Ds stands for the diameter of the rod portion before receiving the load F. In this method, the measurement was performed 10 times for each set of 10 samples (100 samples in total), and the average value of the 10 measurement results was used as a measurement result obtained by using a method of the related art. Two lower cylindrical rods and two upper cylindrical rods are equally spaced. When the length of a measurement target rod is shorter than the space between these two rods, 20 measurement samples are used for one measurement.

In addition, the above-mentioned compression change rate is one of the indices indicating hardness, and in general, it may sometimes be referred to as hardness. Accordingly, in the present specification, the compression change rate is also referred to as “hardness”.

### <Flavor-Generating Segment>

The flavor-generating segment 21 is formed by wrapping the fillers 211 and the plate-shaped susceptor 212 with a piece of wrapping paper 213. The fillers 211 may include at least one selected from, for example, tobacco leaves containing an aerosol-source material, shredded tobacco, a tobacco sheet, tobacco granules, a nicotine-carrying ion-exchange resin, and a tobacco extract, or may be these components. A method of filling the space enclosed by the wrapping paper 213 with the fillers 211 are not particularly limited. For example, the fillers 211 may be wrapped with the wrapping paper 213, or the fillers 211 may be injected into the area inside the wrapping paper 213 formed in a tubular shape. In the case where the tobacco fillers 211 each have a substantially rectangular parallelepiped shape having a longitudinal direction, the tobacco fillers 211 may be injected in such a manner that their longitudinal directions are random directions in the wrapping paper 213 or may be injected so as to be aligned in the axial direction of a tobacco-containing segment or in a direction perpendicular to the axial direction. In addition, in the case of using a tobacco sheet, the tobacco sheet may be cut into pieces each having a width of 0.5-2.0 mm, inclusive (e.g., each having a length of 5-40 mm, inclusive) and injected in a space around the plate-shaped susceptor in a random orientation, or the tobacco sheet may be cut into pieces each having a width of 1.0-3.0 mm, inclusive (e.g., each having a length of 5-40 mm, inclusive) and aligned parallel to the airflow direction. Alternatively, the tobacco sheet that has been crimped (longitudinally striped) may be inserted in a gathered manner. As a result of the flavor-generating segment 21 being heated, a tobacco component, the aerosol-source material, and water that are contained in the fillers 211 are vaporized, and then, these are caused to flow to the mouthpiece segment 22 by inhalation.

Aspects of the fillers 211 and aspects in which the fillers 211 are injected into the flavor-generating segment 21 will now be described more specifically. The conditions in the following aspects can be combined to the greatest extent possible.
(a) After a leaf, a vein, a stem, a root, a flower, or the like of a tobacco plant of a species selected from Nicotiana tabacum species, such as a yellow species, a Burley species, an orient species, and a native species, Nicotiana rustica species, and so forth has been collected, the collected material is dried such that the amount of moisture contained therein is about 10% by weight to about 15% by weight and is prepared as a base material. The various species of tobacco plants and different collected portions of tobacco plants can be blended in accordance with a desired flavor. The base material is cut into shreds each having a width of about 0.5 mm to about 1.5 mm, and the shreds can be injected into a wrapping paper having a cylindrical shape in a random orientation or so as to be substantially oriented in the vertical direction.
(b) After a leaf, a vein, a stem, a root, a flower, or the like of a tobacco plant of a species selected from Nicotiana tabacum species, such as a yellow species, a Burley species, an orient species, and a native species, Nicotiana rustica species, and so forth has been collected, the collected material is grinded, mixed with water and a binder, and homogenized. Then, it is formed into a sheet shape or a granular shape or extruded into a rod shape so as to be prepared as a base material. The various species of tobacco plants and different collected portions of tobacco plants can be blended in accordance with a desired flavor. In the case of using the base material having a granular shape (having an average particle diameter of 0.2 mm to 2.0 mm), the base material can be injected into a cylindrical wrapping paper. In the case of using the base material having a sheet shape (cut into shreds each having a thickness of 50 μm to 300 μm, a width of 0.5 mm to 1.5 mm, and a length of 5 mm to 40 mm), the base material can be injected into a cylindrical wrapping paper in a random orientation, can be injected into a cylindrical wrapping paper so as to be substantially oriented in the vertical direction, or can be gathered and injected into a cylindrical wrapping paper while its sheet shape is maintained (a plurality of channels through which air flows may be formed in the longitudinal direction).
(c) A leaf, a vein, a stem, a root, a fruit, a flower, or the like of a plant of a species selected from herbal plants such as mint, basil, thyme, coriander, rosemary, parsley, fennel, lemongrass, and cinnamon, tea leaves, coffee beans and so forth is collected, dried such that the amount of moisture contained therein is about 10% by weight to about 15% by weight, and prepared as a base material. Various herb plants, tea leaves and coffee beans may be blended in accordance with a desired flavor. The base material is cut into shreds each having a width of about 0.5 mm to about 1.5 mm, and the shreds can be injected into a wrapping paper having a cylindrical shape in a random orientation or so as to be substantially oriented in the vertical direction.
(d) A porous member (a member having an open pore structure) that is mainly made of fibers of a non-tobacco plant, such as paper (having a thickness of 50 μm to 200 μm and a basis weight of 30 g/m² to 200 g/m²) that is a piece of wet laid non-woven fabrics containing wood pulp as a main raw material or a non-woven fabric sheet (having a thickness of 200 μm to 2,000 μm and a basis weight of 30 g/m² to 200 g/m²) that is a piece of dry laid non-woven fabrics containing natural fibers or synthetic fibers as a main raw material, is prepared as a base material. In the case of such a base material, an additive such as a flavor source can be externally added to pore portions, and the additive is stably held at normal temperature due to the pore structure. The base material is cut into shreds each having a width of about 0.5 mm to about 1.5 mm, and the shreds can be injected into a cylindrical wrapping paper in a random orientation or can be injected into a cylindrical wrapping paper so as to be substantially oriented in the vertical direction. Alternatively, it can be gathered and injected into a cylindrical wrapping paper while its sheet shape is maintained (a plurality of channels through which air flows may be formed in the longitudinal direction).
(e) A member containing a polymer as a main raw material is prepared as a base material. The member containing a polymer as a main raw material is not particularly limited, and for example, a member obtained by mixing a polysaccharide thickener, such as gellan gum, carrageenan, pectin, or agar, water, and an additive together, homogenizing the mixture, and then evaporating the moisture contained in the mixture can be used. Depending on the type of the polysaccharide thickener, the presence of cations such as calcium ions may sometimes strengthen the intermolecular crosslinked structure, resulting in a firmer gel, and thus, a calcium salt or a potassium salt may be added as necessary. The method of evaporating the moisture is not particularly limited, and for example, a method such as heating at normal temperature, heating under reduced pressure, or freeze-drying can be used. In addition, the member may have an open pore structure or may have a closed pore structure. For example, as an example of the member having an open pore structure, a gel with a low-density open pore structure (also referred to as an organic aerogel) can be obtained by homogenizing a gelling agent, a gelling accelerator, and water so as to form a wet gel having a crosslinked structure between organic molecules and then volatilizing the moisture while leaving the crosslinked structure by supercritical carbon dioxide treatment or freeze-drying treatment. In this case, a flavor source such as a flavor, a tobacco extract, or ground tobacco may be homogenized together with another raw material, or the flavor source may be externally added to pores in the pore structure after the organic aerosol has been generated. For example, as an example of the member having a closed pore structure, a gel in which droplets or solid masses of a flavor source are dispersed in a polysaccharide can be obtained by homogenizing the polysaccharide, water and the flavor source, such as a flavor or a tobacco extract, and then drying and heating them at normal pressure. Although this gel has a pore structure, the pores in the pore structure are closed with respect to the outside at room temperature. In an aspect in which the flavor source is added into the pores, the pores are opened by heating or adding moisture thereto, and the flavor source in the pores is released. The base material can be processed into a granular shape (having an average particle diameter of 0.2 mm to 2.0 mm) and injected into a wrapping paper having a cylindrical shape. Alternatively, the base material that has been processed into a sheet shape (having a thickness of 50 μm to 300 μm) can be cut into shreds each having a width of about 0.5 mm to about 1.5 mm and then can be injected into a cylindrical wrapping paper in a random orientation, can be injected into a cylindrical wrapping paper so as to be substantially oriented in the vertical direction, or can be gathered and injected into a cylindrical wrapping paper while its sheet shape is maintained (a plurality of channels through which air flows may be formed in the longitudinal direction).

Although the length of the circumference of the flavor-generating segment 21 is not particularly limited, the length is preferably 16 mm to 25 mm, more preferably 20 mm to 24 mm, and further preferably 21 mm to 23 mm.

The length of the flavor-generating segment 21 in the airflow direction is not particularly limited and is normally, for example, 7 mm or greater, preferably 10 mm or greater, and more preferably 12 mm or greater. In addition, the length of the flavor-generating segment 21 in the airflow direction is normally 60 mm or less, preferably 30 mm or less, and more preferably 20 mm or less.

The filling ratio of the fillers 211 to the total amount of the flavor-generating segment 21 is normally 0.2-0.7 mg/mm³, inclusive, based on the inner void volume of the flavor-generating segment 21.

The airflow resistance of the flavor-generating segment 21 is, for example, 5-60 mmH₂O, inclusive, preferably 10-40 mmH₂O, inclusive, and more preferably 15-35 mmH₂O, inclusive. In addition, regarding the filling density of the fillers 211 in the flavor-generating segment 21, the filling ratio (the filling density) of the fillers 211 to the total amount of the flavor-generating segment 21 may normally be 0.2-0.7 mg/mm³, inclusive, and may be 0.2-0.6 mg/mm³, inclusive, based on the inner void volume of the flavor-generating segment 21. Within such a range, for example, heat generated by the plate-shaped susceptor can be sufficiently transmitted to the fillers 211, and unnecessary filtration of a flavor component can be suppressed at the time of inhalation, so that favorable release can be ensured.

The fillers 211 holds the plate-shaped susceptor 212 inside the flavor-generating segment 21. The material of the plate-shaped susceptor 212 is, for example, a metal, and a specific example thereof is any one of aluminum, iron, an iron alloy, a stainless steel, nickel, and a nickel alloy, or a combination of two or more of these. For example, carbon can also be used other than a metal. However, a metal is preferable from the standpoint of easily forming continuous ridge-like raised portions, which will be described later, and from the standpoint of enabling favorable electromagnetic induction heating. The plate-shaped susceptor 212 is, for example, a plate-shaped member extending in the airflow direction. The plate-shaped susceptor 212 is heated by an eddy current that is generated in the plate-shaped susceptor 212 by a fluctuating electromagnetic field generated by the inductor 32. The plate-shaped susceptor 212 that has been heated heats the fillers 211 located therearound so as to form an aerosol. Note that the plate-shaped susceptor 212 may have a through hole extending therethrough in its thickness direction. In addition, the plate-shaped susceptor 212 may include a projecting portion projecting in the thickness direction or the airflow direction and a recessed portion recessed in the thickness direction or the airflow direction. Furthermore, two or more plate-shaped susceptors 212 may be arranged in parallel or in series in the airflow direction. In addition to the plate-shaped susceptor 212, or instead of the plate-shaped susceptor 212, the flavor-generating segment 21 may include a susceptor having a different shape such as, for example, a thread shape or a granular shape. By increasing the surface area of the plate-shaped susceptor 212 that is in contact with the fillers 211, the efficiency of aerosol generation can be improved can be improved.

Note that the fillers 211 may include an aerosol-source material that is in a liquid state at 25° C. or an aerosol-source material that is in a gel state at 25° C.

Examples of the aerosol-source material that is in a liquid state at 25° C. include one or more selected from the group consisting of glycerin, propylene glycol, triacetin, 1,3-butanediol, and the like. The content percentage of the aerosol-source material in a liquid state with respect to the weight of the fillers 211 is normally 5-50% by weight, inclusive, preferably 10-35% by weight, inclusive, and more preferably 15-30% by weight, inclusive.

In the case where the liquid aerosol-source material is included in the fillers 211, the liquid may sometimes migrate to a wrapping paper or a mouthpiece member during manufacture or transport. By containing an aerosol-source material that is in a gel state at 25° C. into the fillers 211, migration of the aerosol-source material can be prevented from occurring during the above-mentioned manufacture or transport.

An aerosol-source material that is in a gel state at 25° C. can be formed by, for example, mixing a required amount of a polysaccharide (gellan gum, agar, sodium alginate, carrageenan, starch, modified starch, cellulose, modified cellulose, pectin) or a protein (collagen, gelatin) into an aerosol-source material (glycerin, propylene glycol, triacetin, 1,3-butanediol), which is the above-mentioned aerosol-source material that is in a liquid state at 25° C. For example, an aerosol-source material that is in a gel state at 25° C. can be obtained by mixing 0.2% by weight to 1.0% by weight of native gellan gum into glycerin containing 5% by weight to 30% by weight of water. Also when another thickener is used, the amount of the thickener may be determined depending on the required gelling property. The content percentage of the aerosol-source material in a gel state with respect to the weight of the fillers 211 is normally 5-50% by weight, inclusive, preferably 10-35% by weight, inclusive, and more preferably 15-30% by weight, inclusive.

Components that can be included in the fillers 211 will be described in detail below. However, the manner in which the components are included in the fillers 211 is not particularly limited. For example, the components may be added during manufacture of the fillers 211 or may be added after manufacture of the fillers 211, and more specifically, the components may be added to the base materials in the specific aspects (a) to (e) which have been described above.

The fillers 211 may include a flavor material. The type of the flavor material is not particularly limited, and examples of the flavor material include a flavoring agent and a taste agent from the standpoint of imparting good smoke taste. In addition, a coloring agent, a humectant, and a preservative may be optionally included as other components. The properties and states of the flavor material and the other components are not limited, and for example, they may be liquid or solid. One of them may be used alone, or any two or more of them may be used in combination in any ratio.

Regarding a preferable flavor of the flavoring agent, a single type of flavor may be used alone, or any two or more types of flavors may be used in combination in any ratio. A component that provides cool sensation or warm sensation may be used. Examples of the type of the flavoring agent include a sugar and a sugar-based flavor, licorice (Glycyrrhiza), cocoa, chocolate, a fruit juice and a fruit, a spice, a Western liquor, a herb, vanilla, and a flower-based flavor. In addition, as the flavoring agent, for example, the types of flavoring agents described in “Collection of Well-known Prior Arts (Flavoring Agent)” (published by Japan Patent Office, Mar. 14, 2007), “Latest Handbook of Flavoring Agents (popular edition)” (Feb. 25, 2012, edited by Soichi Arai et al., Asakura Publishing Co., Ltd.), and “Tobacco Flavoring for Smoking Products” (June, 1972, R. J. REYNOLDS TOBACCO COMPANY) can be used.

More specific examples of the flavoring agent include isothiocyanates, indoles and derivatives thereof, ethers, esters, ketones, fatty acids, aliphatic higher alcohols, aliphatic higher aldehydes, aliphatic higher hydrocarbons, thioethers, thiols, terpene hydrocarbons, phenol ethers, phenols, furfural and derivatives thereof, aromatic alcohols, aromatic aldehydes, and lactones.

Further specific examples of the flavoring agent include acetoanisole, acetophenone, acetylpyrazine, 2-acetylthiazole, an alfalfa extract, amyl alcohol, amyl butyrate, trans-anethole, star anise oil, apple juice, Peru balsam oil, beeswax absolute, benzaldehyde, benzoin resinoid, benzyl alcohol, benzyl benzoate, benzyl phenylacetate, benzyl propionate, 2,3-butanedione, 2-butanol, butyl butyrate, butyric acid, caramel, cardamom oil, carob absolute, β-carotene, carrot juice, L-carvone, β-caryophyllene, Cassia bark oil, cedarwood oil, celery seed oil, chamomile oil, cinnamaldehyde, cinnamic acid, cinnamyl alcohol, cinnamyl cinnamate, citronella oil, DL-citronellol, a clary sage extract, coffee, cognac oil, coriander oil, cumin aldehyde, davana oil, δ-decalactone, γ-decalactone, decanoic acid, dill herb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethylpyrazine, 2,5-dimethylpyrazine, 2,6-dimethylpyrazine, ethyl 2-methylbutyrate, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethylvanillin, ethylvanillin glucoside, 2-ethyl-3,(5 or 6)-dimethyl pyrazine, 5-ethyl-3-hydroxy-4-methyl-2(5H)-furanone, 2-ethyl-3-methylpyrazine, eucalyptol, fenugreek absolute, genet absolute, gentian root infusion, geraniol, geranyl acetate, grape juice, guaiacol, a guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(p-hydroxyphenyl)-2-butanone, sodium 4-hydroxyundecanoate, immortelle absolute, β-ionone, isoamyl acetate, isoamyl butyrate, isoamyl phenylacetate, isobutyl acetate, isobutyl phenylacetate, jasmine absolute, kola nut tincture, labdanum oil, lemon terpeneless oil, a licorice extract, linalool, linalyl acetate, lovage root oil, maple syrup, menthol, menthone, L-menthyl acetate, p-methoxy benzaldehyde, methyl-2-pyrrolyl ketone, methyl anthranilate, methyl phenylacetate, methyl salicylate, 4′-methylacetophenone, methylcyclopentenolone, 3-methylvaleric acid, Mimosa absolute, syrup, myristic acid, nerol, nerolidol, γ-nonalactone, nutmeg oil, δ-octalactone, octanal, octanoic acid, orange flower oil, orange oil, orris root oil, palmitic acid, ω-pentadecalactone, peppermint oil, petitgrain Paraguay oil, phenethyl alcohol, phenethyl phenylacetate, phenylacetic acid, piperonal, a plum extract, propenyl guaethol, propyl acetate, 3-propylidenephthalide, prune juice, pyruvic acid, a raisin extract, rose oil, rum, sage oil, sandalwood oil, spearmint oil, Styrax absolute, marigold oil, tea distillate, α-terpineol, terpinyl acetate, 5,6,7,8-tetrahydroquinoxaline, 1,5,5,9-tetramethyl-13-oxacyclo(8.3.0.0(4.9))tridecane, 2,3,5,6-tetramethylpyrazine, thyme oil, a tomato extract, 2-tridecanone, triethyl citrate, 4-(2,6,6-trimethyl-1-cyclohexenyl)2-butene-4-one, 2,6,6-trimethyl-2-cyclohexene-1,4-dione, 4-(2,6,6-trimethyl-1,3-cyclohexadienyl)2-butene-4-one, 2,3,5-trimethylpyrazine, γ-undecalactone, γ-valerolactone, a vanilla extract, vanillin, veratraldehyde, violet leaf absolute, citral, mandarin oil, 4-(acetoxymethyl) toluene, 2-methyl-1-butanol, ethyl 10-undecenoate, isoamyl hexanoate, 1-phenylethylacetic acid, lauric acid, 8-mercaptomenthone, sinensal, hexyl butyrate, a plant powder (herb powder, flour powder, spice powder, tea powder: cocoa powder, carob powder, coriander powder, licorice powder, orange peel powder, rose hip powder, chamomile flower powder, lemon Verbena powder, peppermint powder, leaf powder, spearmint powder, black tea powder, etc.), camphor, isopulegol, cineol, mint oil, Eucalyptus oil, 2-1-menthoxy ethanol (COOLACT (registered trademark) 5), 3-1-menthoxy propane-1,2-diol (COOLACT (registered trademark) 10), 1-menthyl-3-hydroxybutyrate (COOLACT (registered trademark) 20), p-menthane-3,8-diol (COOLACT (registered trademark) 38D), N-(2-hydroxy-2-phenylethyl)-2-isopropyl-5,5-dimethylcyclohexane-1-carboxamide (COOLACT (registered trademark) 370), N-(4-(cyanomethyl)phenyl)-2-isopropyl-5,5-dimethylcyclohexanecarboxamide (COOLACT (registered trademark) 400), N-(3-hydroxy-4-methoxyphenyl)-2-isopropyl-5,5-dimethylcyclohexanecarboxamide, N-ethyl-p-menthane-3-carboamide (WS-3), ethyl-2-(p-menthan-3-carboxamide) acetate (WS-5), N-(4-methoxyphenyl)-p-menthane carboxamide (WS-12), 2-isopropyl-N,2,3-trimethylbutyramide (WS-23), 3-1-menthoxy-2-methylpropane-1,2-diol, 2-1-menthoxy ethane-1-ol, 3-1-menthoxy propane-1-ol, 4-1-menthoxy butane-1-ol, menthyl lactate (FEMA3748), menthone glycerin acetal (Frescolat MGA, FEMA3807, FEMA3808), 2-(2-1-menthyloxyethyl) ethanol, menthyl glyoxylate, menthyl 2-pyrrolidone-5-carboxylate, menthyl succinate (FEMA3810), N-(2-(pyridin-2-yl)-ethyl)-3-p-menthane carboxamide (FEMA4549), N-(ethoxycarbonylmethyl)-p-menthane-3-carboxamide, N-(4-cyanomethylphenyl)-p-menthane carboxamide, and N-(4-aminocarbonylphenyl)-p-menthane.

Examples of the taste agent include components having sweetness, sourness, saltiness, umami, bitterness, acerbity, kokumi, and so forth.

Examples of the component having sweetness include a saccharide, a sugar alcohol, and a sweetener. Examples of the saccharide include monosaccharides, disaccharides, oligosaccharides, and polysaccharides. Examples of the sweetener include natural sweeteners and synthetic sweeteners.

Examples of the component having sourness include an organic acid (and a sodium salt thereof). Examples of the organic acid include acetic acid, adipic acid, citric acid, lactic acid, malic acid, succinic acid, and tartaric acid.

Examples of the component having bitterness include caffeine (extract), naringin, and a wormwood extract.

Examples of the component having saltiness include sodium chloride, potassium chloride, sodium citrate, potassium citrate, sodium acetate, and potassium acetate.

Examples of the component having umami include sodium glutamate, sodium inosinate, and sodium guanylate.

Examples of the component having acerbity include tannin and shibuol.

Examples of the coloring agent include natural pigment and a synthetic pigment. Examples of the natural pigment include caramel, turmeric, red yeast rice, Gardenia, safflower, carotene, marigold, and annatto. Examples of the synthetic pigment include a tar dye and titanium oxide.

Examples of the humectant include lipids such as a wax, cera, glycerin, a medium-chain fatty acid triglyceride, and fatty acids (including short-chain, medium-chain, and long-chain fatty acids).

Although the total flavor material content in the fillers 211 is not particularly limited, for example, the total flavor material content is normally 10 ppm or greater, preferably 10,000 ppm or greater, and more preferably 50,000 ppm or greater. In addition, the total flavor material content is normally 250,000 ppm or less, preferably 200,000 ppm, more preferably 150,000 ppm or less, and still more preferably 100,000 ppm or less from the standpoint of imparting good smoke taste.

The fillers 211 may include a flavor modifier, and examples of the flavor modifier include an acid and an alkali.

The type of acid that can be used as the flavor modifier is not particularly limited as long as it is edible, and an organic acid is an example. In particular, an acid is preferable because it is liquid at normal temperature (15° C. to 25° C.) and can be easily added in the case where the flavor adjusting agent is mixed with a solvent and sprayed. Specific examples of the acid include stearic acid, isostearic acid, linoleic acid, oleic acid, palmitic acid, myristic acid, dodecanoic acid, capric acid, benzoic acid, isobutyric acid, propionic acid, adipic acid, acetic acid, vanillylmandelic acid, maleic acid, glutaric acid, fumaric acid, succinic acid, lactic acid, glycolic acid, and glutamic acid. One of these acids may be used alone, or any two or more of them may be used in combination in any ratio. Among these acids, for example, isostearic acid, linoleic acid, oleic acid, isobutyric acid, propionic acid, acetic acid, lactic acid, or the like is preferable as an acid that is liquid at 15° C. to 25° C., and lactic acid is more preferable because it is inexpensive, has a minimal odor, and has little effect on the flavoring agent.

The type of the alkali that can be used as the flavor modifier is not particularly limited as long as it is edible, and may be, for example, an alkali metal carbonate, an alkali metal citric acid salt, sodium carbonate, sodium hydrogen carbonate, potassium carbonate, or a mixture of these or may be an aqueous solution obtained by dissolving these in suitable water.

The fillers 211 may include a granular susceptor, which will be described later. The amount of the granular susceptor included in the fillers 211 may be, for example, 1-20% by weight, inclusive, preferably 1-15% by weight, inclusive, and more preferably 1-10% by weight, inclusive, from the standpoint of being able to efficiently generate an aerosol.

In the case where base materials such as those mentioned in (a) to (e), which have been described above, are used as the fillers 211, a method of including the aerosol-source material, the flavor material, the flavor modifier, the granular susceptor, or another component in the base material is not particularly limited, and for example, the following methods can be employed. The aerosol-source material, the flavor material, the flavor modifier, the granular susceptor, or another component will hereinafter be referred to as an additive component.
(1) After the base material has been produced, the additive component is externally added to the base material as is.
(2) After the base material has been produced, a liquid obtained by dissolving or dispersing the additive component in a solvent is externally added to the base material.
(3) After the base material has been produced, the additive component is dissolved or dispersed in a solvent, and in addition, a thickener is added to the solvent so as to adjust the viscosity (from a high-viscosity liquid state to a gel state). Then, it is externally added to the base material. By adding an additive in such a manner, exudation of the additive when a large amount of the additive is added can be suppressed.
(4) After the base material has been produced, a carrier carrying the additive component is externally added to the base material.
(5) The additive component is externally added to the base material as is during the manufacturing process of the base material.
(6) A liquid obtained by dissolving or dispersing the additive component in a solvent is externally added to the base material during the manufacturing process of the base material.
(7) A carrier carrying the additive component is externally added to the base material during the manufacturing process of the base material.

The method of including an additive in the base material during the manufacturing process of the base material as described in (5) to (7) is particularly easy to be employed in the above specific aspects (b), (d), and (e) of the fillers 211.

Examples of the above-mentioned carrier include dextrin, cyclodextrin, calcium carbonate, activated carbon, silica gel, and ion exchange resin. In addition, it is preferable that the average particle diameter of the carrier be about 50 μm to about 500 μm from the standpoint of handleability.

The thickness of the plate-shaped susceptor 212 is, for example, 30-1,000 μm, inclusive, preferably 50-500 μm, inclusive, and more preferably 50-200 μm, inclusive. The length of the plate-shaped susceptor 212 in the airflow direction is, for example, 6-60 mm, inclusive, and it is preferable that the length of the plate-shaped susceptor 212 in the airflow direction be equal to or larger than a value obtained by subtracting 4 mm from the length of the flavor-generating segment 21 in the airflow direction and equal to or smaller than the length of flavor-generating segment 21 in the airflow direction. The length of the plate-shaped susceptor 212 in the width direction, which is perpendicular to the airflow direction, is, for example, 1-7 mm, inclusive, preferably 2-6 mm, inclusive, and more preferably 3-5 mm, inclusive.

By setting the above-mentioned ranges, for example, the entire flavor-generating segment can be efficiently heated.

The plate-shaped susceptor is required to have such strength that the plate-shaped susceptor will not break when it is inserted into the flavor-generating segment at high speed. When the plate-shaped susceptor is subjected to a tensile test with its two ends in the airflow direction held, it is preferable that the breaking strength thereof be 2 N or greater. The tensile test can be conducted at a tension rate of 50 mm/min by using, for example, a rheometer manufactured by Sun Scientific CO., LTD., model number CR-3000EX-L. Although it depends on the material or the shape of the plate-shaped susceptor, when a tensile test is conducted, the plate-shaped susceptor first stretches, and the tensile stress measured by a load cell of the rheometer increases. If the plate-shaped susceptor is kept pulled, it will become cut. The above-mentioned breaking strength refers to the maximum value of the tensile stress recorded by the rheometer. After the tensile stress has reached its maximum just before breakage, there will be no tensile stress any more.

As the wrapping paper 213, paper, a polymer film, or the like can be used, and the wrapping paper 213 may be formed of a single sheet of paper, a single polymer film, or the like or may be formed of a plurality of these. In addition, the outer side or the inner side of the wrapping paper 213 may be coated. For example, it may be selected from a laminated sheet in which paper and a polymer film are laminated together, and paper having a water-resistant coating provided on either or both of the inner side and the outer side thereof. The air permeability of the wrapping paper 213 may be low. For example, the air permeability may be less than 15 Coresta. It is preferable that the air permeability be less than 10 Coresta. With such a configuration, generation of stains due to volatilization or leakage of a volatile flavor source or the aerosol-source material from the flavor-generating segment before use and during use can be prevented.

If a metal is present at a portion of the wrapping paper 213 located between the inductor 32 and the plate-shaped susceptor, a fluctuating electromagnetic field generated by the inductor 32 will be absorbed during use, so that the fluctuating electromagnetic field will be hindered from being transmitted to the plate-shaped susceptor as designed. Thus, it is preferable that the wrapping paper 213 located between the inductor 32 and the plate-shaped susceptor do not contain any metal.

### <Cooling Segment>

The mouthpiece segment may include the cooling segment, and the cooling segment 23 may be formed of a cylindrical member as an example. The cooling segment is located further downstream than a flavor-generating segment 21. The vapor of the aerosol-source material or the flavor source that has been heated and vaporized is introduced into the cooling segment, cooled, and liquefied (aerosolized). It is preferable that the cooling segment reduce a temperature without significantly removing the vapor of the aerosol-source material or the flavor source generated in the flavor-generating segment 21. For example, at the time of inhalation, the difference between the segment internal temperature at an inlet of the cooling segment and the segment internal temperature at an outlet of the cooling segment may sometimes become equal to or greater than 20° C.

As an aspect of the cooling segment, the cooling segment may be a paper tube obtained by processing a sheet of paper or a plurality of sheets of paper bonded together into a cylindrical shape. Further, in order to enhance the cooling effect by bringing external air at room temperature into contact with high-temperature vapor, it is preferable that a hole for introducing the external air be formed in the circumference of the paper tube. By coating the inner surface of the paper tube with a polymer coating such as polyvinyl alcohol or a polysaccharide coating such as pectin, the cooling effect can be also enhanced by utilizing heat of solution associated with the heat absorption by the coating or a phase change of the coating. The airflow resistance of the cylindrical cooling segment is zero mmH₂O.

As another aspect of the cooling segment, it is also preferable to dispose a cooling sheet member inside a paper tube formed in a cylindrical shape. In this case, by providing one or a plurality of air flow channels in the airflow direction, a low level of component filtration can be achieved while cooling is performed by the cooling sheet member. It is desirable that the airflow resistance of the cooling segment including the cooling sheet disposed therein be 0 mmH₂O to 30 mmH₂O.

The total surface area of the cooling sheet member may be, for example, 300-1,000 mm²/mm. This surface area is a surface area per length (mm) of the cooling sheet member in the airflow direction. It is preferable that the total surface area of the cooling sheet member be 400 mm²/mm or greater, and more preferably 450 mm²/mm or greater, and on the other hand, it is preferable that the total surface area of the cooling sheet member be 600 mm²/mm or less, and more preferably 550 mm²/mm or less.

It is desirable that the internal structure of the cooling segment 23 has a large surface area. Thus, in a preferred embodiment, the cooling sheet member may be formed of a thin sheet material that is wrinkled in order to form channels in the airflow direction and then pleated, gathered, and folded. The larger the number of folds or pleats in a given volume of the element, the larger the total surface area of the cooling sheet member.

In some embodiments, the thickness of a component material of the cooling sheet member may be, for example, 5-500 μm, inclusive, and may be, for example, 10-250 m, inclusive.

The cooling sheet member can be made of a material having a specific surface area of 10-100 mm²/mg, inclusive. In one embodiment, the specific surface area of the component material may be about 35 mm²/mg.

The specific surface area can be determined by taking into consideration a material of the cooling sheet member with a known width and a known thickness. For example, the material of the cooling sheet member can be polylactic acid having an average thickness of 50 μm, varying within ±2 μm. In the case where the material of the cooling sheet member has a known width of, for example, 200-250 mm, inclusive, as mentioned above, the specific surface area and the density can be calculated.

In addition, it is desirable to use paper as the material of the cooling sheet member from the standpoint of reducing the environmental load. Paper that is used as the material of the cooling sheet preferably has a basis weight of 30 g/m² to 100 g/m² and a thickness of 20 um to 100 μm. From the standpoint of reducing the removal amount of a flavor source component and an aerosol-source material component in the cooling segment, it is desirable that the air permeability of paper used as the material of the cooling sheet be low, and it is preferable that the air permeability be equal to or less than 10 Coresta. By coating paper, which is used as the material of the cooling sheet, with a polymer coating such as polyvinyl alcohol or a polysaccharide coating such as pectin, the cooling effect can be also enhanced by utilizing heat of solution associated with the heat absorption by the coating or a phase change of the coating.

The cylindrical member and the lining sheet 25 may have a perforation (ventilation filter (Vf)) 231 that is formed so as to extend through them. The outside air is introduced into the cooling segment 23 at the time of inhalation due to the presence of the perforation 231. Accordingly, an aerosol vaporized component that is generated as a result of heating the flavor-generating segment 21 comes into contact with the outside air and is liquefied due to a decrease in its temperature, so that an aerosol is formed. Although the diameter of the perforation 231 (the distance across the perforation 231 through the center) is not particularly limited, the diameter may be, for example, 0.5-1.5 mm, inclusive. The number of the perforations 231 is not particularly limited and may be one or two or more. For example, a plurality of perforations 231 may be formed in the circumference of the cooling segment 23.

The amount of the outside air that is introduced through the perforation 231 is preferably 85% by volume or less, and more preferably 80% by volume or less, with respect to the volume of the entire gas inhaled by a user. By setting the amount of the outside air to be 85% by volume or less, a reduction in flavor smoke taste as a result of being diluted with the outside air can be sufficiently suppressed. Note that this is also referred to as a ventilation ratio.

It is preferable that the lower limit of the ventilation ratio be 55% by volume or greater, and more preferably 60% by volume or greater from the standpoint of cooling performance. The ventilation ratio can be adjusted by appropriately adjusting the hole diameter of the perforation 231 and the number of the perforations 231.

The ventilation ratio is measured in conformity with an ISO standard method (ISO6565:2015) by using, for example, an NCQA (manufactured by JT tohsi Co., Ltd.). When the air is inhaled from the mouthpiece end surface of the non-combustion-heating-type tobacco at a predetermined air flow rate (17.5 cc/sec), the atmosphere is introduced into the non-combustion heating tobacco from an end portion of the non-combustion-heating-type tobacco, a side surface of a flavor-generating segment 21, and the perforation 231. The ventilation ratio is the ratio of the air flow rate at which the air is introduced from the perforation 231 to the air flow rate (17.5 cc/sec) at which the air is inhaled from the mouthpiece end surface.

It is preferable that the cooling segment 23 provide a small resistance to the air passing through the tobacco rod, and the airflow resistance of the cooling segment 23 is, for example, 0-30 mmH₂O, inclusive, preferably 0-25 mmH₂O, inclusive, and more preferably 0-20 mmH₂O, inclusive.

Preferably, the cooling segment 23 does not substantially affect the inhalation resistance of an aerosol-generating article. In addition, it is preferable that the amount of pressure drop from the upstream end of the cooling segment 23 to the downstream end of the cooling segment 23 is small.

In some embodiments, the generated aerosol may sometimes be reduced in temperature by 10° C. or more when it passes through the cooling segment 23 and is inhaled by a user. In some embodiments, the generated aerosol may sometimes be reduced in temperature by 15° C. or more in another aspect and 20° C. or more in yet another aspect when it passes through the cooling segment 23 and is inhaled by a user. The cooling segment 23 can be formed by other means. For example, the cooling segment 23 may be formed of a bundle of longitudinally extending tubes. The cooling segment 23 may be formed by extrusion, molding, lamination, injection or shredding of a suitable material.

The cooling segment 23 can be formed by, for example, wrapping a pleated, gathered, or folded sheet material with cooling segment wrapping paper. In some embodiments, the cooling segment 23 may include a wrinkled sheet material that is made of paper or a polymer film, which is crimped in the airflow direction and then gathered into a rod shape, and that is shaped by a cooling segment wrapping sheet such as, for example, cooling segment wrapping paper, which is filter paper. With such a configuration, since a plurality of channels through which air flows are formed in the airflow direction of the cooling segment, airflow resistance is reduced. On the other hand, the heat of the air or a vaporized component is absorbed by the surrounding paper or polymer film when the air or the vaporized component passes through the plurality of channels, so that the air or the vaporized component is cooled.

The cooling sheet member, the cooling segment wrapping paper (particularly, the inner surface thereof), and the cylindrical member, which have been mentioned above, may include a flavor modifier. An example of the flavor modifier is an acid. Although the type of the acid is not particularly limited, an edible acid can be used, and for example, an organic acid can be used. In particular, it is preferable that the acid be liquid at 15° C. to 25° C., that is, at room temperature. This is because, if the acid is liquid at room temperature, the acid can be applied to wrapping paper without dissolving it in a solvent such as water. In addition, if the acid is held inside the wrapping paper while it is in a liquid state, the acid may be uniformly distributed inside the wrapping paper, and the contact efficiency between the acid and a flavor component may be improved, so that the acid can efficiently act on the flavor component. Specific examples of the acid include stearic acid, isostearic acid, linoleic acid, oleic acid, palmitic acid, myristic acid, dodecanoic acid, capric acid, benzoic acid, isobutyric acid, propionic acid, adipic acid, acetic acid, vanillylmandelic acid, maleic acid, glutaric acid, fumaric acid, succinic acid, lactic acid, glycolic acid, and glutamic acid. Among these acids, examples of an acid that is a liquid at 15° C. to 25° C. are isostearic acid, linoleic acid, oleic acid, isobutyric acid, propionic acid, acetic acid, lactic acid, and the like. One of these acids may be used alone, or any two or more of them may be used in combination in any ratio. Among these acids, lactic acid is preferable because it is inexpensive, has a minimal odor, and has little effect on the flavoring agent. An example of the flavor modifier is an alkali. More specifically, it may be an alkali metal carbonate, an alkali metal citric acid salt, sodium carbonate, sodium hydrogen carbonate, potassium carbonate, or a mixture of these or may be an aqueous solution obtained by dissolving these in suitable water.

The cooling segment 23 can be formed into a rod shape whose length in the airflow direction is, for example, 10-40 mm, inclusive, and preferably 10-25 mm, inclusive. For example, the length of the cooling segment in the airflow direction can be 18 mm.

In an embodiment of a portion of a cross section of the cooling segment 23 in the circumferential direction, the cross-sectional shape of the cooling segment 23 in the airflow direction is a substantially circular shape, and its diameter can be 5.5-8.0 mm, inclusive. For example, the diameter of the cooling segment 23 can be about 7 mm.

In the case where the cooling segment has a perforation for introducing the external air, when the air is inhaled from the suction end at 17.5 cc/sec, the ratio of the amount of the air flowing into the cooling segment through the perforation to the total amount of air flowing into the cooling segment is normally 55% or greater, preferably 60% or greater, and more preferably 65% or greater, and is normally 85% or less, preferably 80% or less, and more preferably 75% or less. Within such a range, cooling of an aerosol and dilution of a flavor component are performed in a balanced manner.

### <Filter Segment>

The mouthpiece segment may include the filter segment 24. The filter segment 24 is not particularly limited as long as it includes a filter element and has a common function as a filter and can be formed by, for example, processing a tow made of a synthetic fiber (also simply referred to as a “tow”) or a material such as paper into a cylindrical shape. Examples of a common function of a filter include adjustment of the amount of air to be mixed at the time of inhaling an aerosol or the like, reduction of smoke taste, and reduction of nicotine and tar. However, it is not necessary for a filter to have all of these functions. In addition, for an electrical heating type tobacco product that generates a smaller amount of flavor components compared with a paper-wrapped tobacco product and in which the filling ratio of the tobacco fillers is likely to be low compared with a paper-wrapped tobacco product, a function of preventing falling of the tobacco fillers while suppressing a filtration function is one of the important functions.

Although the length of the circumference of the filter segment 24 is not particularly limited, the length is preferably 16 mm to 25 mm, more preferably 20 mm to 24 mm, and further preferably 21 mm to 23 mm. Preferably, the length of the filter segment 24 in the airflow direction can be selected from a range of 4-30 mm, inclusive, and more preferably, the length of the filter segment 24 in the airflow direction can be selected from a range of 7-20 mm, inclusive. Preferably, the airflow resistance can be selected from a range of 10-60 mmH₂O, inclusive, and more preferably, the airflow resistance can be selected from a range of 15-40 mmH₂O, inclusive. It is preferable that the length of the filter segment 24 in the airflow direction be 5 mm to 9 mm, and more preferably 6 mm to 8 mm. Although the cross section of the filter segment 24 is not particularly limited, it can be, for example, a circular shape, an oval shape, a polygonal shape, or the like. In addition, the filter segment 24 may include an additive release container or flavoring agent beads, which will be described later, or a flavoring agent may be directly added.

Note that the shape and the dimensions of the filter element can be suitably adjusted such that the shape and the dimensions of the filter segment 24 are within the above-mentioned ranges.

The configuration of the filter segment is not particularly limited and can be a plane filter that includes a single filter segment or a multi-segment filter, such as a dual filter or a triple filter, that includes a plurality of filter elements. By employing a multi-segment filter, a different function can be imparted to each segment. In addition, the outer side of a filling layer may be wrapped with one or a plurality of sheets of filter segment wrapping paper.

Regarding the airflow resistance per segment of the filter segment 24, the airflow resistance can be appropriately changed in accordance with the amount, the material, or the like of a filler with which the filter segment 24 is filled. For example, when the filler is made of cellulose acetate fibers, the airflow resistance can be increased by increasing the amount of the cellulose acetate fibers injected into the filter segment 24. When the filler is made of cellulose acetate fibers, the filling density of the cellulose acetate fibers can be 0.13 g/cm³ to 0.18 g/cm³. Note that that the airflow resistance is a value measured by using, for example, an airflow resistance measuring instrument (product name: SODIMAX, manufactured by SODIM).

The filter segment 24 can be manufactured by a commonly known method for manufacturing a filter segment. For example, when a synthetic fiber, such as cellulose acetate tow, is used as a material of the filter element, the filter segment 24 can be manufactured by a method in which a polymer solution containing a polymer and a solvent is spun into thread and in which the thread is crimped. For example, the method described in International Publication No. 2013/067511 can be used as the above method.

In the manufacture of the filter segment 24, adjustment of airflow resistance and addition of additives (a commonly known absorbent, a flavoring agent (e.g., menthol)), granular active carbon, a flavoring-agent holding material, and so forth) to the filter element can be appropriately designed.

The filter element included in the filter segment 24 is not particularly limited, and a commonly known aspect may be employed. For example, a filter element that is formed by processing cellulose acetate tow into a cylindrical shape can be employed. Although the filament denier and the total denier of the cellulose acetate tow are not particularly limited, in the case of a mouthpiece member having a perimeter of 22 mm, it is preferable that the filament denier be 5-15 g/9000 m, inclusive, and it is preferable that the total denier be 8,000-25,000 g/9000 m, inclusive. Examples of the cross-sectional shape of fibers of the cellulose acetate tow include a circular shape, an oval shape, a Y-shape, an I-shape, and an R-shape. In the case of a filter filled with cellulose acetate tow, in order to increase the hardness of the filter, a plasticizer, such as triacetin, may be added in an amount that is 5-10% by weight, inclusive, of the weight of the cellulose acetate tow. Instead of the cellulose acetate filter, a paper filter that is filled with sheet-shaped pulp paper may be used. As the filter element, paper or a piece of nonwoven fabric that is formed into a gathered shape may be used. In addition, the filter element may include the above-mentioned flavor modifier.

The filter element may include a crushable additive release container (e.g., a capsule) with a crushable shell made of gelatin or the like. The capsule (also called “additive release container” in this technical field) is not particularly limited, and a commonly known capsule may be employed. For example, a crushable additive release container with a crushable shell made of gelatin or the like can be employed, and the diameter thereof can be 2-4 mm, inclusive. In this case, when the capsule is broken before, while, or after a user uses a tobacco product, a liquid or a substance (usually a flavor agent) contained in the capsule is released. Then, the liquid or substance is transferred to tobacco smoke during the use of the tobacco product, and transferred to the ambient environment after the use of the tobacco product.

From the standpoint of improving the strength and the structural stiffness, the filter segment 24 may include wrapping paper (filter-plug wrapping paper) with which the above-mentioned filter element is wrapped. The wrapping paper is not particularly limited, and the wrapping paper may be bonded with an adhesive. The adhesive may include a hot-melt adhesive, and the hot melt adhesive may include polyvinyl alcohol. In the case where the filter is formed of two or more segments, it is preferable to wrap each of the segments with first wrapping paper and then collectively wrap these segments with second wrapping paper.

The material of the wrapping paper is not particularly limited, and a commonly known material can be used. The wrapping paper may include, for example, a filler such as calcium carbonate.

The thickness of the wrapping paper is not particularly limited and is normally 20-140 μm, inclusive, preferably 30-130 μm, inclusive, and more preferably 40-100 μm, inclusive.

The basis weight of the wrapping paper is not particularly limited and is normally 20-100 gsm, inclusive, preferably 22-95 gsm, inclusive, and more preferably 23-90 gsm, inclusive.

Although the wrapping paper may or may not be coated, it is preferable that the wrapping paper be coated with a desired material from the standpoint of imparting a function other than strength or structural stiffness. In addition, the above-mentioned flavor modifier may be contained in the wrapping paper, particularly the inner surface (the side that is in contact with the filter element) of the wrapping paper.

The filter segment 24 may further include a center hole segment having one or a plurality of hollow portions. The center hole segment is usually positioned closer to the flavor-generating segment than the filter element and is preferably positioned adjacent to the cooling segment.

### <First Modification of Plate-Shaped Susceptor>

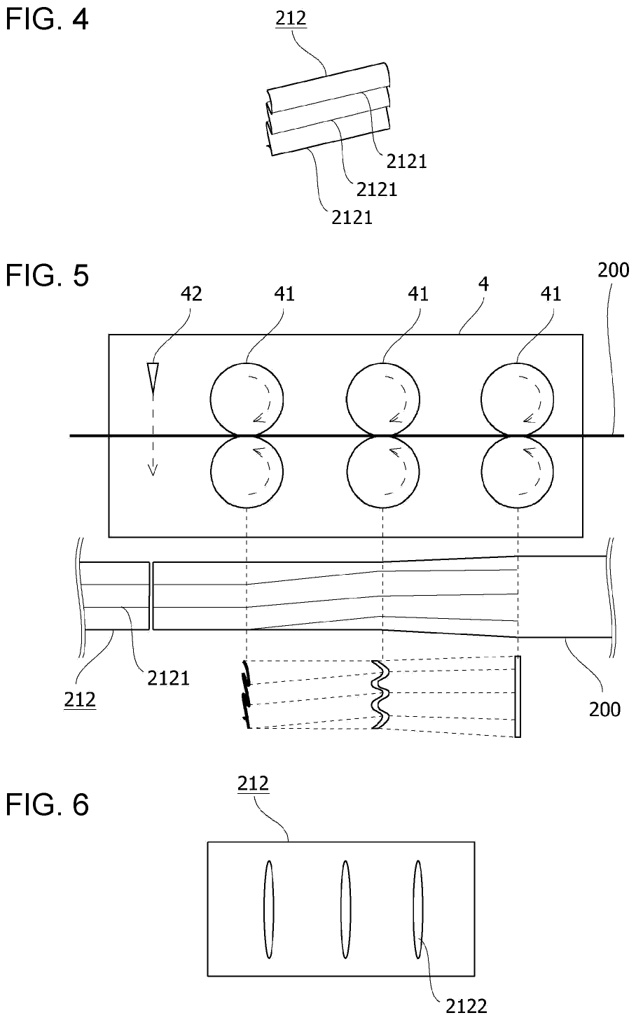

The plate-shaped susceptor 212 may be a metal plate having irregularities. FIG. 4 is a perspective view illustrating an example of the plate-shaped susceptor 212. Note that, in the descriptions of modifications, components that correspond to those in the above embodiment are denoted by the same reference signs, and the descriptions thereof will be omitted. The plate-shaped susceptor 212 may include ridge-like raised portions 2121 formed of projections that are continuous with each other in the airflow direction and each of which projects toward at least one of the front side and the rear side, and the susceptor 212 illustrated in FIG. 4 includes three continuous ridge-like raised portions 2121.

FIG. 5 is a diagram schematically illustrating a method of manufacturing the plate-shaped susceptor. As illustrated in the upper part of FIG. 5, a manufacturing apparatus 4 includes a plurality of rollers 41 and performs rolling while feeding a metal plate 200, which is a material, in a predetermined direction. The manufacturing apparatus 4 further includes a cutter 42 for cutting the metal plate 200 to form the plate-shaped susceptor 212. The middle part of FIG. 5 illustrates a schematic plan view of the metal plate at the corresponding position in the upper part. The lower part of FIG. 5 illustrates a schematic sectional view of the metal plate at the corresponding position in the upper part. The metal plate 200 is pulled back and forth in the feeding direction between, for example, the rollers 41, extends in the feeding direction, and contracts in a width direction thereof that is perpendicular to the feeding direction. In this case, irregularities having a wave-like cross section are formed on the metal plate 200. The metal plate 200 is further rolled by the rollers 41, and the irregularities are crushed so as to form the ridge-like raised portions 2121. According to such projections, the position at which the fillers 211 hold the plate-shaped susceptor 212 in the flavor-generating segment 21 is less likely to be shifted, and in the case where the plate-shaped susceptor 212 includes a coating layer, which will be described later, the coating layer may easily be held by the plate-shaped susceptor 212. In addition, the continuous ridge-like raised portions 2121 of the plate-shaped susceptor 212 extend along the airflow direction, so that the vapor generated as a result of the tobacco component, the aerosol-source material, and so forth contained in the fillers 211 being vaporized can be caused to smoothly flow along the airflow direction. In other words, the spaces between the ridge-like raised portions 2121 extending along the airflow direction can be appropriately used as flow paths through which the vapor of the tobacco component and the aerosol-source material, which have been mentioned above, flow.

Note that the raised portions 2121 may be partially interrupted in the airflow direction or may be formed so as to be approximately parallel to the airflow direction. The number of the raised portions 2121 may be one or more and is not limited to three. The raised portions 2121 may be formed in a meandering shape instead of a linear shape when viewed in plan view.

### <Second Modification of Plate-Shaped Susceptor>

FIG. 6 is a plan view depicting a modification of the plate-shaped susceptor. In the case illustrated in FIG. 6, the plate-shaped susceptor 212 has a plurality of through holes 2122 extending between the front side and the rear side thereof. The through holes 2122 can be formed by, for example, forming slits into the metal plate 200 by using the rollers 41 having blades and then rolling or pulling the metal plate 200 by using the rollers 41 so as to enlarge the slits. Also with such through holes, the position at which the fillers 211 hold the plate-shaped susceptor 212 in the flavor-generating segment 21 is less likely to be shifted, and the surface area of the plate-shaped susceptor 212 that is in contact with the fillers 211 can be increased, so that the efficiency of aerosol generation can be improved.

### <Third Modification of Plate-Shaped Susceptor>

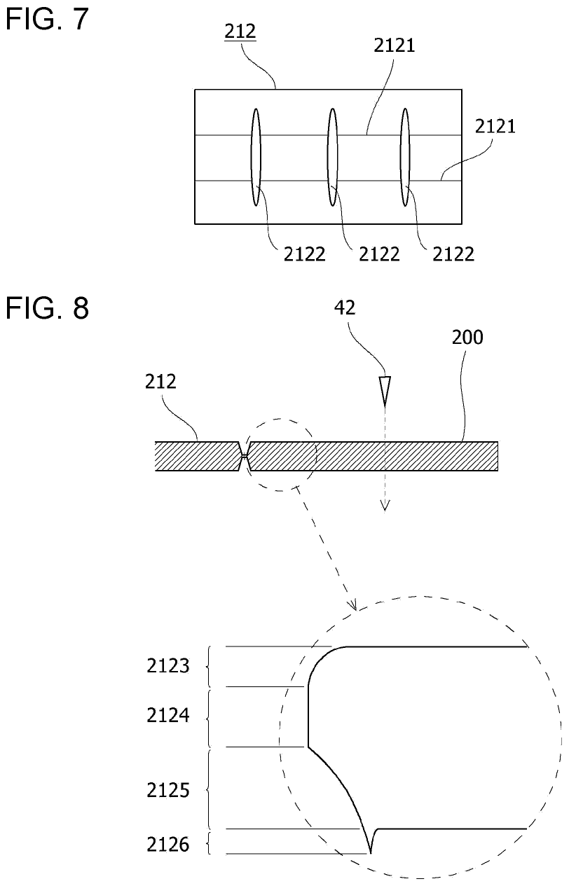

FIG. 7 is a plan view depicting another modification of the plate-shaped susceptor. In the present modification, the plate-shaped susceptor 212 includes the ridge-like raised portions 2121 between the through holes 2122. In other words, the raised portions 2121, which is formed by the manufacturing method illustrated in FIG. 5, are formed on the plate-shaped susceptor 212 having the through holes 2122 illustrated in FIG. 6. Although the raised portions 2121 are continuously formed between the through holes 2122 in the case illustrated in FIG. 7, the raised portions 2121 may be partially interrupted in the longitudinal direction or may be formed so as to be approximately parallel to the longitudinal direction. In addition, the number of the raised portions 2121 is not limited.

### <Fourth Modification of Plate-Shaped Susceptor>

FIG. 8 is a diagram depicting an end surface of the plate-shaped susceptor 212. An end portion of the plate-shaped susceptor 212 in the airflow direction may be provided with a protrusion that is formed so as to protrude in the thickness direction. FIG. 8 illustrates a first curved surface portion 2123 of the front surface of the end surface of the plate-shaped susceptor 212, a second curved surface portion 2124 of the front surface of the end surface, a third curved surface portion 2125 located in the vicinity of the rear surface, and a protrusion 2126 protruding toward the rear surface side. Also with such a protrusion, the position at which the fillers 211 hold the plate-shaped susceptor 212 in the flavor-generating segment 21 is less likely to be shifted. Note that it is also preferable to form a protrusion on an end portion of the plate-shaped susceptor 212 in the width direction instead of on the end portion of the plate-shaped susceptor 212 in the thickness direction in order to prevent the position at which the fillers 211 hold the plate-shaped susceptor 212 from shifting. Thus, an end portion of the metal plate 200 in the airflow direction may be provided with a protrusion that is formed so as to protrude in a direction, such as the thickness direction or the width direction, perpendicular to the airflow direction. This protrusion is also effective in preventing displacement of a coating layer, which will be described later.

### <Fifth Modification of Plate-Shaped Susceptor>

At least one of the front side and the rear side of the plate-shaped susceptor 212 may be subjected to a texture treatment such as embossing or punching. The three-dimensional shape or the pattern of the surface obtained by a texture treatment is not particularly limited, and various types of texture treatments can be performed for the purpose of improving the efficiency of aerosol generation of the plate-shaped susceptor 212, preventing displacement of the plate-shaped susceptor 212 in the flavor-generating segment 21, and so forth. By performing a texture treatment, a contact area with a coating layer, which will be described later, is increased, and the amount of heat that is transferred from the plate-shaped susceptor to the coating layer is increased.

### <Modification of Flavor-Generating Segment>

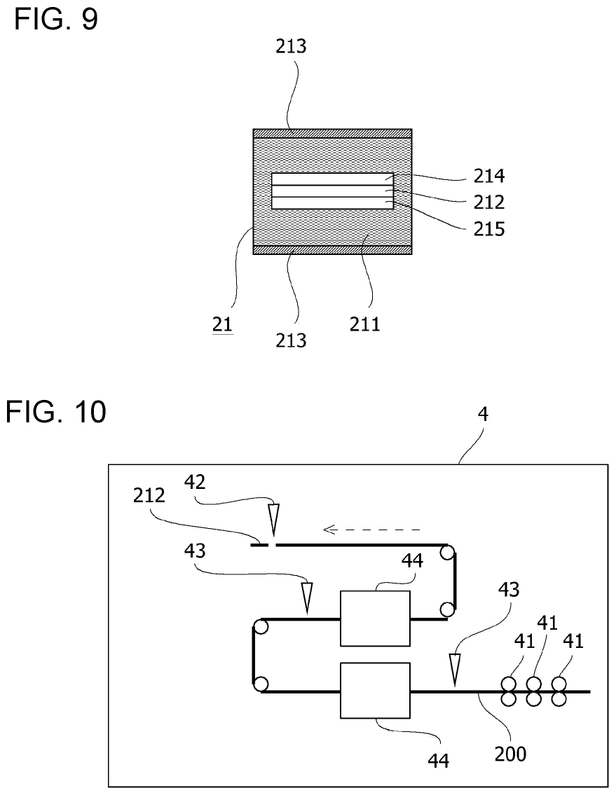

FIG. 9 is a diagram depicting a modification of the flavor-generating segment. The flavor-generating segment 21 may include either or both of a first coating layer 214 coating one of the front side and the rear side of the plate-shaped susceptor 212 and a second coating layer 215 coating the other of the front side and the rear side of the plate-shaped susceptor 212. For example, the first coating layer 214 and the second coating layer 215 are each a flavor source including an aerosol-based material. The flavor source may include, for example, a tobacco powder, an aerosol-source material, a binder, and water. In addition, the fillers 211 may be a plant fiber or the like that does not contain shredded tobacco, such as, for example, wood pulp. By laminating such a coating layer on the periphery of the plate-shaped susceptor 212, the efficiency of generation of an aerosol and a flavor component can be improved. In addition, in the case where the plate-shaped susceptor 212 includes the above-mentioned ridge-like raised portions 2121, the coating layers may be easily held by the plate-shaped susceptor 212. Note that, in the present specification, the term “coating layer” refers to both the “first coating layer” and the “second coating layer” unless otherwise particularly stated.

The first coating layer and the second coating layer can each be formed by coating the plate-shaped susceptor with a mixture obtained by uniformly mixing pulverized tobacco plant (one or more selected from the group consisting of a mesophyll, a vein, a stem, a root, a flower, and so forth) (having an average particle size of 30-300 μm, inclusive), a binder (one or more selected from the group consisting of a modified cellulose, a modified starch, a protein, a polysaccharide thickener, and so forth), an aerosol-source material (one or more selected from the group consisting of glycerin, propylene glycol, triacetin, 1,3-butanediol, and so forth), and water, and in addition, a flavoring agent, a flavor modifier, and plant fibers other than a tobacco plant may be added. The flavor can be adjusted by blending a plurality of different species of tobacco plants as tobacco plants that can be contained. The coating layers may each contain 1-4% by weight, inclusive, of nicotine.

In addition, in the case where a tobacco plant is contained in the first coating layer and the second coating layer, by containing different components in the coating layers from each other, the range of flavor variations can be increased. For example, by changing the particle sizes of pulverized tobacco plants, it is possible to contain a component capable of delivering a flavor component in an early stage of heating into one of the coating layers and to contain a component capable of delivering a flavor component in a later stage of heating into the other coating layer.

As a specific example of a material included in the coating layers, the above-described specific aspects (b), (c), or (e) of the fillers 211 can be used, and it is preferable to use (b) from the standpoint of exhibiting a flavor. In addition, additive components, such as an aerosol-source material, a flavor material, a flavor modifier, a granular susceptor, or other components, that can be added to the above-mentioned fillers 211 may be added to a coating material in a similar manner. Furthermore, regarding the method of adding these additive components to the base material, the method of adding additive components to the base material in the above description of the fillers 211 can be used.

The surface of any one of the first and second coating layers or the surfaces of both of the first and second coating layers may be subjected to a treatment for forming surface irregularities. The surface area is increased by such a treatment, so that the flavor component delivery can be improved.

The thicknesses of the first coating layer 214 and the second coating layer 215 are each independently, for example, 200-2,000 μm, inclusive, preferably 200-1,000 μm, inclusive, and more preferably 300-800 μm, inclusive. By setting such thickness ranges, aerosol generation and flavor source release are favorably maintained.

FIG. 10 is a diagram depicting a method of manufacturing the plate-shaped susceptor that has been coated. In the case illustrated in FIG. 10, the manufacturing apparatus 4 includes the rollers 41, coating units 43, ovens 44, and the cutter 42. In the coating units 43, a slurry containing a tobacco powder and an aerosol-source material is sequentially layered on the front side and the rear side of the metal plate 200 rolled by the rollers 41 and is dried in the ovens 44. The coated metal plate 200 is cut by the cutter 42, so that the plate-shaped susceptor 212 on which the first coating layer 214 and the second coating layer 215 are laminated is obtained.

### <First Modification of Coating Layer>

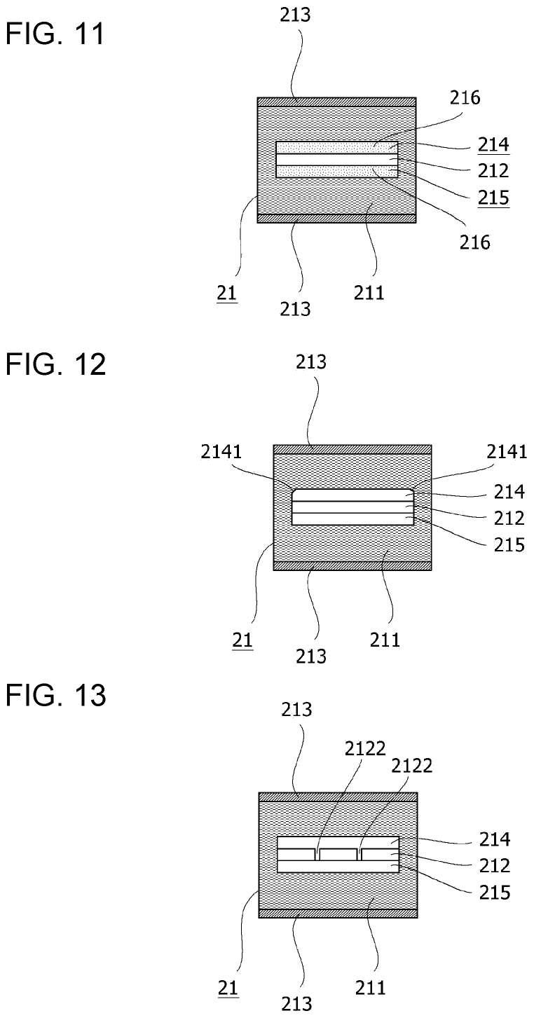

FIG. 11 is a diagram depicting a modification of the coating layers. At least one layer selected from the first coating layer 214 and the second coating layer 215 includes a granular susceptor 216. The material of the granular susceptor 216 is, for example, a metal, and specific examples thereof include aluminum, iron, an iron alloy, stainless steel, nickel, and a nickel alloy, and combinations of two or more of these. For example, carbon can also be used other than a metal. However, a metal is preferable from the standpoint of enabling favorable electromagnetic induction heating. For example, the granular susceptor 216 is dispersed and mixed in the above-mentioned slurry, for example and disposed in the first coating layer 214 and the second coating layer 215. It is preferable that the granular susceptor 216 be uniformly dispersed in the coating layers. The granular susceptor 216 is also heated by electromagnetic induction heating, and in the case where the first coating layer 214 and the second coating layer 215 include an aerosol-source material, these generate an aerosol. With such a configuration, an aerosol is more efficiently generated.

The particle diameter of the granular susceptor is normally 30-300 μm, inclusive, preferably 30-100 μm, inclusive, and more preferably 50-100 μm, inclusive, from the standpoint of being able to efficiently generate an aerosol.

The content percentage of the granular susceptor in each of the coating layers is, independently, normally 1-20% by weight, inclusive, preferably 1-15% by weight, inclusive, and more preferably 1-10% by weight, inclusive, from the standpoint of being able to efficiently generate an aerosol.

In addition, the average of the distances from the surfaces of the particles of the granular susceptor 216 to the surface of the plate-shaped susceptor 212 is normally 100-1,000 μm, inclusive, may be 250-1,000 μm, inclusive, may be 100-500 μm, inclusive, and preferably 150-400 μm, inclusive. Excessive contact between the plate-shaped susceptor 212 and the granular susceptor can be prevented by uniformly dispersing the granular susceptor in the coating layers. With such an average distance, excessive heating can be prevented.

The granular susceptor 216 may be made of a metal different from that of the plate-shaped susceptor 212. For example, the material of the granular susceptor 216 may be selected in such a manner that the Curie temperature thereof is lower than the Curie temperature of the plate-shaped susceptor 212. The control unit 34 may detect, on the basis of the magnitude of the current flowing through the inductor 32, a change in magnetic properties of the granular susceptor 216 due to the temperature of the granular susceptor 216 reaching the Curie temperature and control the temperature of the plate-shaped susceptor 212.

In the case where the granular susceptor 216 included in the coating layers is made of a type of metal different from the type of metal contained in the plate-shaped susceptor 212, a coating layer that does not include the granular susceptor 216 may be applied as primary coating before the coating layers are applied to the plate-shaped susceptor 212, and then the coating layers that include the granular susceptor may be applied. This can prevent occurrence of galvanic corrosion due to direct contact between different types of metals. In addition, instead of applying the above-mentioned coating layer that does not include the granular susceptor as primary coating, the plate-shaped susceptor 212 may be coated with an insulating polymer, starches, or celluloses as primary coating.

### <Second Modification of Coating Layer>

FIG. 12 is a diagram depicting another modification of the coating layers. In the case illustrated in FIG. 12, chamfered portions 2141 are provided at end portions of the first coating layer 214 in the airflow direction. Note that the chamfered portions 2141 may each be formed by flat chamfering in which a corner of a rectangular parallelepiped shape is chamfered into a flat shape or may each be formed by round chamfering in which a corner is rounded. Instead of forming the chamfered portions 2141 of the first coating layer 214, or in addition to formation of the form chamfered portions 2141 of the first coating layer 214, chamfered portions may be provided at end portions of the second coating layer 215 in the airflow direction. By providing such chamfered portions, when the plate-shaped susceptor 212 provided with the coating layers is applied is introduced into the flavor-generating segment 21 at high speed in high-speed manufacture of the flavor-generating segment 21, the corner portions of the coating layers are introduced into the flavor-generating segment 21 without breaking or falling off. Since the coating layers include tobacco, it is suitable to prevent the coating layers from falling off in order to stably achieve consumer satisfaction.

### <Third Modification of Coating Layer>

FIG. 13 is a diagram depicting another modification of the coating layers. In the case illustrated in FIG. 13, the plate-shaped susceptor 212 has the plurality of through holes 2122 extending between the front side and the rear side thereof, and the interior of each of the through holes 2122 may be at least partially filled with the first coating layer 214, and the interior of each of the through holes may be entirely filled with the first coating layer 214. Note that the material with which the interior of each of the through holes is filled may be at least one of the material of the first coating layer 214 and the material of the second coating layer 215. By increasing the surface area of the plate-shaped susceptor 212 that is in contact with the coating layers, the efficiency of aerosol generation can be improved. In addition, since the through holes 2122 are each filled with a portion of the coating layer, shear displacement between the plate-shaped susceptor 212 and the coating layer can be prevented.

### <Fourth Modification of Coating Layer>

The first coating layer 214 and the second coating layer 215 may be made of the same material or made of different materials from each other.

### <Sixth Modification of Plate-Shaped Susceptor>

The plate-shaped susceptor 212 may have different surface roughnesses on its front and rear sides. Appropriate setting of surface roughness can suppress separation of the first coating layer 214 and the second coating layer 215 from the susceptor 212. In addition, even in a case where the coating layers are not provided, displacement of the plate-shaped susceptor 212 in the flavor-generating segment 21 can be suppressed by setting the surface roughnesses. By setting the surface roughness on the front side and the surface roughness on the rear side to be different from each other, the contact surface area of the first coating layer 214 with the plate-shaped susceptor and the contact surface area of the second coating layer 215 with the plate-shaped susceptor become different from each other. Consequently, there will be a difference in thermal conductivity, and thus, the timing of volatilization and generation of the flavor component and the aerosol-source material present in the first coating layer 214 and the timing of volatilization and generation of the flavor component and the aerosol-source material present in the second coating layer 215 can be set to be different from each other.

### <Modification of Non-Combustion-Heating-Type Tobacco>

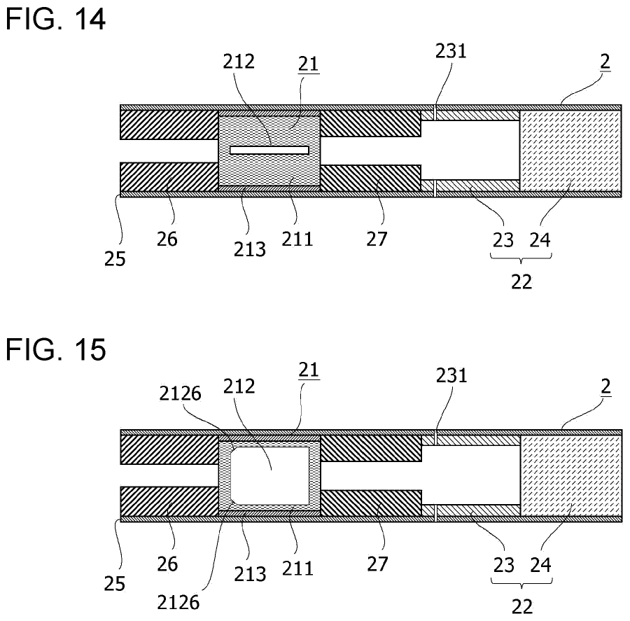

FIG. 14 is a diagram depicting a modification of the non-combustion-heating-type tobacco. FIG. 14 is a vertical cross-sectional view of the non-combustion-heating-type tobacco 2 cut along the thickness direction of the plate-shaped susceptor 212. The non-combustion-heating-type tobacco 2 includes an end segment 26, the flavor-generating segment 21, a support segment 27, and the mouthpiece segment 22. The end segment 26 is adjacent to the flavor-generating segment 21 and is provided on the side opposite to the side on which the inhalation port of the non-combustion-heating-type tobacco 2 is located. The support segment 27 is provided between the flavor-generating segment 21 and the mouthpiece segment 22. Note that one of the end segment 26 and the support segment 27 may not be provided.

### <End Segment>

The end segment 26 is made of a common filter material, and has, for example, one or more through holes along the airflow direction. Regarding the material of the end segment 26, relatively heat-resistant plant pulp fibers, cellulose fibers, or regenerated cellulose fibers may be the main raw material. The end segment 26 may be formed by solidifying continuous cellulose acetate fibers with a plasticizer (triacetin). By providing the end segment 26, the fillers 211 can be suppressed from dropping off from the flavor-generating segment 21, and the plate-shaped susceptor 212 can be suppressed from popping out of the flavor-generating segment 21. Note that the end segment 26 may be made of a porous solid filter material. The length of the end segment 26 in the airflow direction is, for example, 5-10 mm, inclusive. The airflow resistance of the end segment 26 is, for example, 0-15 mmH₂O, inclusive. By setting the airflow resistance of the end segment to be low, the influence of the entire non-combustion heating tobacco on the airflow resistance can be reduced.

In the flavor-generating segment 21, the fillers 211 may be partially interposed between the plate-shaped susceptor 212 and the end segment 26. In other words, it is not necessary to bring the plate-shaped susceptor 212 into contact with the end segment 26. With such a configuration, direct heating of the end segment 26 by the plate-shaped susceptor 212 can be suppressed, and functional deterioration due to deterioration, deformation, or the like of the end segment 26 as a result of being directly heated can be prevented.

FIG. 15 is an example of a longitudinal sectional view obtained by cutting the non-combustion-heating-type tobacco along the width direction of the plate-shaped susceptor. The plate-shaped susceptor 212 includes chamfered portions 2126 that are formed so as to reduce the width of the end surface of the plate-shaped susceptor 212 facing the end segment 26. Also with such a configuration, the end segment 26 can be suppressed from being heated by the plate-shaped susceptor 212. Consequently, functional deterioration due to deterioration, deformation, or the like of the end segment 26 as a result of being directly heated can be prevented.

### <Modification of End Segment>

The end segment 26 may have a configuration in which an end-segment filler of the end segment 26 is wrapped with end-segment wrapping paper. The end-segment filler of the end segment 26 may include a gathered sheet made of paper or a polymer. The end-segment filler of the end segment 26 may include a gather sheet made of a piece of nonwoven fabric. Apiece of nonwoven fabric in a folded state will hereinafter be referred to as a “gather sheet”. In these aspects, the gather sheet has a through-hole (a channel) formed so as to extend therethrough in the airflow direction. In addition, a piece of nonwoven fabric having a low density may be placed in the end segment while it is in a state of being compressed and folded. In this case, the piece of nonwoven fabric does not have a through hole (a channel) formed so as to extend therethrough in the airflow direction. In addition, the end-segment filler of the end segment 26 may include a so-called flavor source. The flavor source may be, for example, a flavoring agent, a tobacco extract or a tobacco powder. The end-segment wrapping paper of the end segment 26 may be a paper-aluminum laminated sheet. Such end-segment wrapping paper can be heated by using an induced current or can be heated by heat transferred from the plate-shaped susceptor 212 of the flavor-generating segment 21, and in the case where the end segment 26 includes a flavor source, a flavor component can be volatilized by the heat of the end-segment wrapping paper.

### <Support Segment>

The support segment 27 is also made of a common filter material and has, for example, one or more through holes along the airflow direction. The support segment 27 may also be formed by solidifying continuous cellulose acetate fibers with a plasticizer (triacetin). By providing the support segment 27, the plate-shaped susceptor 212 can be suppressed from popping out of the flavor-generating segment 21. Note that the support segment 27 may also be made of a porous solid filter material. A support-segment filler of the support segment 27 may include a gathered sheet made of paper or a polymer. The support-segment filler of the support segment 27 may include a gather sheet made of a piece of nonwoven fabric. In these aspects, it has a through-hole (a channel) formed so as to extend therethrough in the airflow direction. In addition, the support-segment filler of the support segment 27 may include a so-called flavor source. The flavor source may be, for example, a flavoring agent, a tobacco extract or a tobacco powder. A support-segment wrapping paper of the support segment 27 may be a paper-aluminum laminated sheet. The length of the support segment 27 in the airflow direction is, for example, 5 mm to 10 mm. The airflow resistance of the support segment 27 is 0 mmH₂O to 15 mmH₂O. By setting the airflow resistance of the support segment to be low, the influence of the entire non-combustion heating tobacco on the airflow resistance can be reduced. In addition, by setting the airflow resistance of the support segment to be low, the vapor of a flavor component or the vapor of an aerosol-source material generated in the flavor-generating segment 21 can be prevented from being greatly reduced by filtration and adsorption.

### <First Modification of Lining Sheet>

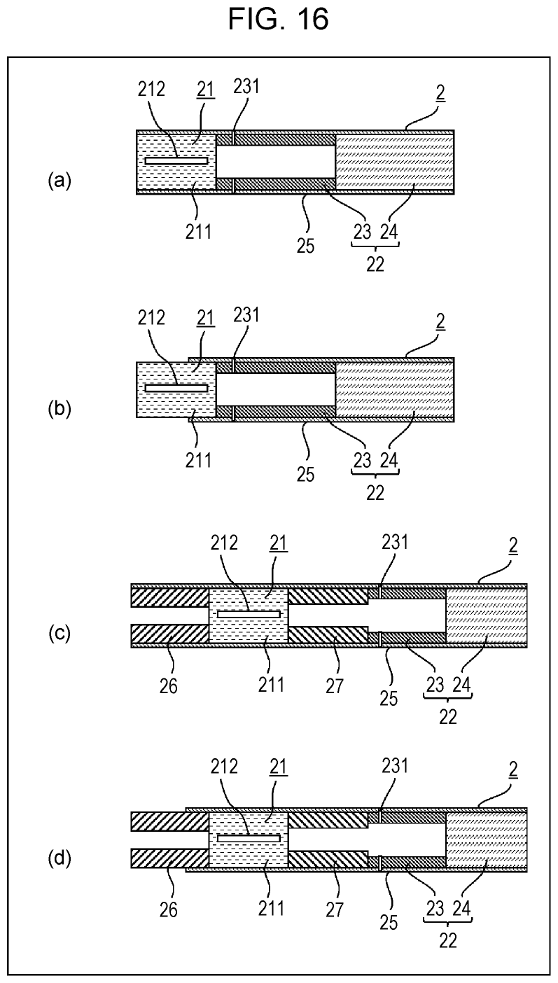

FIGS. 16(a) to 16(d) are diagrams each depicting a modification of the lining sheet. The lining sheet is not particularly limited as long as it at least wraps a portion of the flavor-generating segment 21 and a portion of the mouthpiece segment 22, and the lining sheet can also wrap other segments in addition to these segments. For example, in a configuration in which the end segment 26 and the support segment 27 are provided, the end segment 26, the flavor-generating segment 21, the support segment 27, and the mouthpiece segment 22 may be wrapped with the single lining sheet 25 as illustrated in FIGS. 16(a) to 16(d). By using the lining sheet 25 that is very comfortable to hold in a user's mouth and that has favorable printability, the non-combustion-heating-type tobacco 2 having favorable usage quality and favorable appearance quality can be obtained.

Although the lining sheet is not particularly limited as long as it at least wraps a portion of the flavor-generating segment 21 and a portion of the mouthpiece segment 22, from the standpoint of ensuring sufficient holding comfortability and sufficient printability, it is preferable that the lining sheet 25 at least wrap a portion of the flavor-generating segment 21 and the entire mouthpiece segment 22.

The lining sheet 25 is not particularly limited, and for example, the lining sheet 25 can contain pulp as its main component. Regarding examples of the pulp, the lining sheet 25 may be made of a wood pulp, such as coniferous tree pulp or broadleaf tree pulp, or may be made of mixing a non-wood pulp, such as a flax pulp, a cannabis pulp, a sisal hemp pulp, or an esparto pulp, that is typically used in wrapping paper for tobacco articles. Among these pulps, a single type of pulp may be solely used, or any two or more types of the pulps may be used in combination in any ratio.

In addition, the lining sheet 25 may be formed of a single sheet or may be formed of a plurality of sheets.

Examples of pulps that can be used include a chemical pulp, a ground pulp, a chemiground pulp, and a thermomechanical pulp that are produced by kraft cooking, acidic, neutral, or alkaline sulfite cooking, sodium salt cooking, or the like.

Note that the lining sheet 25 may be manufactured by a manufacturing method, which will be described later, or may be a commercially available product.

The shape of the lining sheet 25 is not particularly limited and may be, for example, a square shape or a rectangular shape.

Although the thickness of the lining sheet 25 is not particularly limited, from the standpoint of holding comfortability and printability, the thickness of the lining sheet 25 is normally 30-60 μm, inclusive, and preferably 40-50 μm, inclusive.

Although the basis weight of the lining sheet 25 is not particularly limited, from the standpoint of holding comfortability and printability, the basis weight of the lining sheet 25 is normally 30-60 gsm, inclusive, preferably 35-50 gsm, inclusive, and more preferably 35-40 gsm, inclusive.

Although the air permeability of the lining sheet 25 is not particularly limited, from the standpoint of holding comfortability and printability, the air permeability of the lining sheet 25 is normally 0-30 Coresta units, and it is preferable that the air permeability of the lining sheet 25 be greater than 0 Coresta unit and equal to or less than 15 Coresta units. The term “air permeability” refers to a value measured in conformity with ISO 2965:2009 and is expressed as an amount (cm³) of a gas that passes through an area of 1 cm² per minute when a pressure difference between the surfaces of paper is 1 kPa. Note that 1 Coresta unit (1 Coresta unit, 1 C.U.) is cm³/(min·cm²) at 1 kPa.

Although the smoothness of the lining sheet 25 is not particularly limited, from the standpoint of holding comfortability and printability, the smoothness of the lining sheet 25 is normally 200-1,500 seconds, inclusive, preferably 250-1,000 seconds, inclusive, and more preferably 300-500 seconds, inclusive.

Although the opacity of the lining sheet 25 is not particularly limited, from the standpoint of ensuring desired appearance quality, the opacity of the lining sheet 25 is normally 70-100%, inclusive, preferably 75-95%, inclusive, and more preferably, 80-90%, inclusive.

The opacity is measured by using a photovolt reflectometer in accordance with JIS-P8138. The smoothness is measured in accordance with JIS-P8117 and JIS-P8119. The basis weight of the sheet is measured in accordance with JIS-P8124.

From the standpoint of being able to block leakage and staining of the liquid contained in the fillers 211 of the flavor-generating segment 21, it is preferable that the lining sheet 25 be a liquid-impermeable sheet examples of which include a sheet obtained by bonding a polymer film containing polyolefin, polyester, or the like as its main component and paper together, and a sheet obtained by applying a coating agent, such as modified cellulose, modified starch, or polyvinyl alcohol, to paper.

The lining sheet 25 may contain a filler in addition to the above-mentioned pulps. Examples of the filler include metal carbonates such as calcium carbonate and magnesium carbonate, metal oxides such as titanium oxide, titanium dioxide, and aluminum oxide, metal sulfates such as barium sulfate and calcium sulfate, a metal sulfide such as zinc sulfide, quartz, kaolin, talc, diatomaceous earth, and gypsum. In particular, from the standpoint of improving brightness and opacity and increasing heating rate, calcium carbonate is preferably contained. One of these fillers may be used alone, or any two or more of them may be used in combination in any ratio.

In addition to the above-mentioned pulp and or filler, various auxiliary agents may be added to the lining sheet 25. For example, the lining sheet 25 may include a water resistance improver in order to improve paper strength when moisture is contained therein. Examples of the water resistance improver include a wet strength agent (a WS agent) and a sizing agent. Examples of the wet strength agent include a urea formaldehyde resin, a melamine formaldehyde resin, and polyamide epichlorohydrin (PAE). Examples of the sizing agent include a rosin soap, an alkyl ketene dimer (AKD), alkenylsuccinic anhydride (ASA), and highly saponified polyvinyl alcohol having a degree of saponification of 90% or more.

A coating agent may be added to at least one of the front and rear surfaces of the lining sheet 25. Although the coating agent is not particularly limited, a coating agent capable of forming a film on a surface of paper and reducing liquid permeability is preferable.

As an example of the coating agent, a lip release agent may be applied to the outer side of the lining sheet 25, and in this case, the comfortability of holding the lining sheet 25 in a user's mouth is improved. As the lip release agent, for example, nitrocellulose, ethylcellulose, or the like can be used. In the case where the lip release agent is applied to the inner side of the lining sheet 25, a liquid component, such as the aerosol-source material contained in the flavor-generating segment 21, can be prevented from permeating the lining sheet 25.

The plurality of segments can be fixed in place by the lining sheet 25 by arranging the plurality of segments on one surface of the inning sheet 25 (the inner side surface of the inning sheet 25 when the segments are wrapped with the inning sheet 25) before or after applying a glue, such as a vinyl acetate emulsion or a starch glue, to the entirety or a portion of the one surface of the inning sheet 25 and then wrapping the plurality of segments. The lining sheet 25 may include a wrap portion that has a width of 1 mm to 3 mm when the lining sheet 25 wraps, and the wrap portion is also glued and fixed in place.

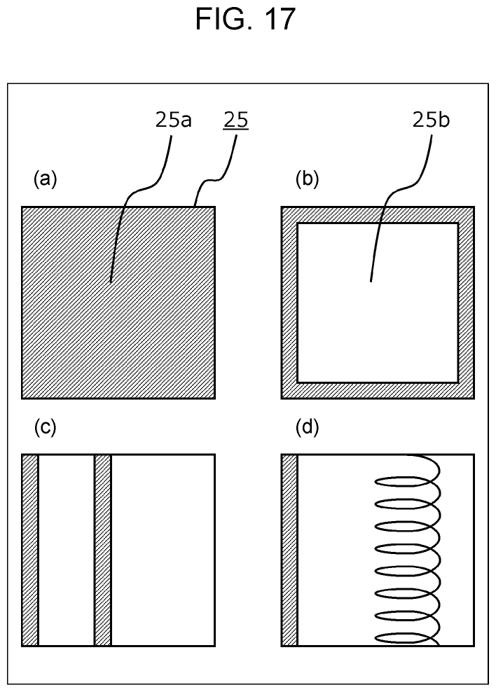

A gluing pattern of the lining sheet 25 is illustrated in FIG. 17. In FIG. 17, reference sign 25a denotes a glued portion, and reference sign 25b denotes non-glued portion.

FIG. 17(a) illustrates a pattern in which the glue is applied to the entire surface of the lining sheet 25.

FIG. 17(b) illustrates a pattern in which the glue is applied to a portion (the entire edge portion) of the lining sheet 25.

FIG. 17(c) illustrates a pattern in which the glue is applied to portions (an edge portion used for fixing an overlapping portion of the lining sheet 25 in place and an inner portion for fixing the plurality of segments in place) of the lining sheet 25.

FIG. 17(d) illustrates another pattern in which the glue is applied to portions (the edge portion used for fixing an overlapping portion of the lining sheet 25 in place and an inner portion for fixing the plurality of segments in place) of the lining sheet 25.

### <Second Modification of Lining Sheet>

The lining sheet 25 may include a plurality of sheet materials (also simply referred to as “sheets”), and the lining sheet 25 may be formed of two sheet materials or may be formed of three or more sheet materials. However, it is preferable that the lining sheet 25 be formed of two sheets from the standpoint of manufacturing costs. The configuration of the lining sheet 25 in the case where the lining sheet 25 includes a plurality of sheet materials is not particularly limited, and for example, the sheet materials may be laminated so as to partially overlap each other or may be laminated so as to entirely overlap each other. However, it is preferable that the lining sheet 25 be formed so as to include a first sheet material (also simply referred to as a “first sheet”) and a second sheet material (also simply referred to as a “second sheet”), which will be described later. Regarding conditions such as the material, the shape, the characteristics of each sheet material, the conditions mentioned in the above first modification can be applied. The materials, the shapes, and the characteristics of the sheet materials may be the same or different from each other.

More specifically, it is preferable that the sheet 25 be formed so as to include at least the first sheet and the second sheet that is positioned outside the first sheet and downstream from the first sheet.

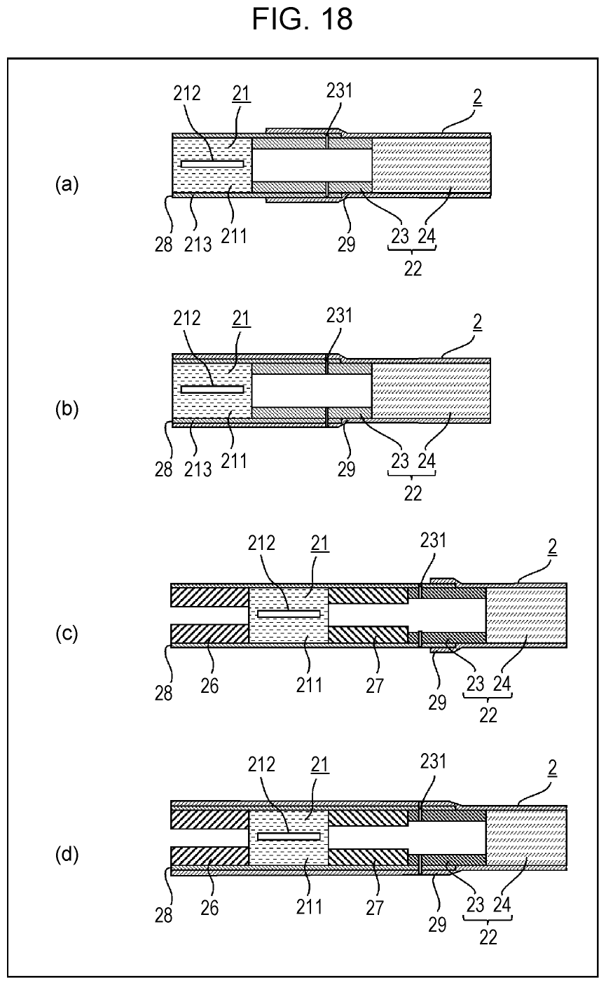

In addition, in a configuration in which the mouthpiece segment 22 includes the cooling segment 23 and the filter segment 24 and in which the cooling segment 23 is positioned upstream from the filter segment 24, as illustrated in FIGS. 18(a) to 18(d), it is more preferable that the lining sheet 25 at least include the first sheet wrapping a portion of the flavor-generating segment and a portion of the cooling segment and the second sheet positioned outside the first sheet and wrapping at least the entire filter segment and a portion of the cooling segment. As in this configuration, in the case where a plurality of short segments are connected to each other by a single type of lining sheet, the segments become out of alignment. However, by connecting the segments in stages as in the present configuration, the segments can be prevented from becoming out of alignment. In addition, one of main conditions required for the first sheet is to block leakage and staining of the liquid contained in the fillers 211 of the flavor-generating segment 21 by losing liquid permeability, and one of main conditions required for the second sheet is to be comfortable to hold in a user's mouth and to have favorable printability. It is advantageous in that sheets suitable for these required conditions can be individually selected.

In addition, in the case where the non-combustion-heating-type flavor inhalation article includes the end segment 26 and the support segment 27, the non-combustion-heating-type flavor inhalation article may include a first sheet 28 that wraps the end segment 26, the flavor-generating segment 21, and the support segment 27, and a second sheet 29 that connects the mouthpiece segment 22 to the end segment 26, the flavor-generating segment 21, and the support segment 27, which are wrapped with the first sheet 28.

The first sheet 28 may have a water-resistant function and/or liquid impermeability. A sheet with a suitable surface that offers a comfortable hold in a user's mouth or a sheet with a suitable surface that provides excellent printability may be used as the second sheet.

In the case where the second sheet is placed at a position such as that illustrated in FIGS. 18(a) to 18(d), it is preferable to be used together with an electrical heating type device that has at least two protrusions formed on the side walls forming the cavity 35 of the chamber as illustrated in FIG. 2 and that is designed such that at least two of these protrusions, or preferably three of the protrusions, are provided so as to come into contact with the second sheet when the non-combustion-heating-type flavor inhalation article is inserted so as to reach the bottom surface, which is the deepest portion of the cavity. More specifically, in such an aspect, when the non-combustion heating tobacco is inserted into the cavity of the electrical heating type device, a user can feel an end surface of the second sheet making into contact or engaging with the cavity of the electrical heating type device, so that excessive insertion of the tobacco can be prevented. In addition, the fixing strength of the non-combustion heating tobacco by the protrusions can be increased. In addition, by wrapping the entire non-combustion heating tobacco with the lining sheet as illustrated in FIGS. 18(b) and 18(d), the rod strength of the non-combustion heating tobacco is increased, and the non-combustion heating tobacco can be prevented from being buckled and damaged when the tobacco is pulled out of and inserted into the cavity of the heating type device. In addition, a decrease in the strength of the lining sheet due to the liquid component contained in the fillers in the flavor-generating segment can be suppressed, and a decrease in the strength due to heating during use (scorching in the case of a cellulose-based sheet, and melting in the case of a polymer-based sheet) can be suppressed. If the strength of the lining sheet is low, the lining sheet may be torn when the non-combustion-heating-type tobacco 2 is pulled out of the electrical heating type device after use, and there is a possibility that some segments such as the flavor-generating segment may remain in the cavity 35. Therefore, it is important to secure the strength of the lining sheet.

The conditions of the first sheet 28 and the second sheet 29, such as their materials, shapes, and characteristics, are not particularly limited, and the above-mentioned conditions of the lining sheet 25 can be applied in a similar manner as long as it can be provided.

Although the thickness of the first sheet 28 is not particularly limited, from the standpoint of holding comfortability and printability, the thickness of the first sheet 28 is normally 30-60 μm, inclusive, and preferably 40-50 μm, inclusive.

Although the basis weight of the first sheet 28 is not particularly limited, from the standpoint of holding comfortability and printability, the basis weight of the first sheet 28 is normally 30-60 gsm, inclusive, preferably 35-50 gsm, inclusive, and more preferably 35-40 gsm, inclusive.

Although the air permeability of the first sheet 28 is not particularly limited, from the standpoint of holding comfortability and printability, the air permeability of the first sheet 28 is normally 0-30 Coresta units, and it is preferable that the air permeability of the first sheet 28 be greater than 0 Coresta unit and equal to or less than 15 Coresta units. The term “air permeability” refers to a value measured in conformity with ISO 2965:2009 and is expressed as an amount (cm³) of a gas that passes through an area of 1 cm² per minute when a pressure difference between the surfaces of paper is 1 kPa. Note that 1 Coresta unit (1 Coresta unit, 1 C.U.) is cm³/(min·cm²) at 1 kPa.

Although the smoothness of the first sheet 28 is not particularly limited, from the standpoint of holding comfortability and printability, the smoothness of the first sheet 28 is normally 200-1,500 seconds, inclusive, preferably 250-1,000 seconds, inclusive, and more preferably 300-500 seconds, inclusive.

Although the opacity of the first sheet 28 is not particularly limited, from the standpoint of ensuring desired appearance quality, the opacity of the first sheet 28 is normally 70-100%, inclusive, preferably 75-95%, inclusive, and more preferably, 80-90%, inclusive.

From the standpoint of being able to block leakage and staining of the liquid contained in the fillers 211 of the flavor-generating segment 21, it is preferable that the first sheet 28 be a liquid-impermeable sheet, and for example, the above-mentioned liquid-impermeable materials can be used in a similar manner as the material of liquid-impermeable sheet.

Although the thickness of the second sheet 29 is not particularly limited, from the standpoint of holding comfortability and printability, the thickness of the second sheet 29 is normally 30-60 μm, inclusive, and preferably 40-50 μm, inclusive.

Although the basis weight of the second sheet 29 is not particularly limited, from the standpoint of holding comfortability and printability, the basis weight of the second sheet 29 is normally 30-60 gsm, inclusive, preferably 35-50 gsm, inclusive, and more preferably 35-40 gsm, inclusive.

Although the air permeability of the second sheet 29 is not particularly limited, from the standpoint of holding comfortability and printability, the air permeability of the second sheet 29 is normally 0-30 Coresta units, and it is preferable that the air permeability of the second sheet 29 be greater than 0 Coresta unit and equal to or less than 15 Coresta units. The term “air permeability” refers to a value measured in conformity with ISO 2965:2009 and is expressed as an amount (cm³) of a gas that passes through an area of 1 cm² per minute when a pressure difference between the surfaces of paper is 1 kPa. Note that 1 Coresta unit (1 Coresta unit, 1 C.U.) is cm³/(min·cm²) at 1 kPa.

Although the smoothness of the second sheet 29 is not particularly limited, from the standpoint of holding comfortability and printability, the smoothness of the second sheet 29 is normally 200-1,500 seconds, inclusive, preferably 250-1,000 seconds, inclusive, and more preferably 300-500 seconds, inclusive.

Although the opacity of the second sheet 29 is not particularly limited, from the standpoint of ensuring desired appearance quality, the opacity of the second sheet 29 is normally 70-100%, inclusive, preferably 75-95%, inclusive, and more preferably, 80-90%, inclusive.

### <Others>

The configurations of the embodiment and the modifications described above can be combined to the fullest extent possible without departing from the problem and the technical idea of the present invention.

### REFERENCE SIGNS LIST

1 non-combustion-heating-type flavor inhalation product
2 non-combustion-heating-type tobacco
200 metal plate
21 flavor-generating segment
211 filler
212 plate-shaped susceptor
2121 raised portion
2122 through hole
2123 first curved surface portion
2124 second curved surface portion
2125 protrusion
2126 chamfered portion
213 wrapping paper
214 first coating layer
2141 chamfered portion
215 second coating layer
216 granular susceptor
22 mouthpiece segment
23 cooling segment
231 perforation
24 filter segment
25 lining sheet
25a glued portion
25b non-glued portion
26 end segment
27 support segment
28 first sheet
29 second sheet
3 electric heating type device
31 body
32 inductor
33 battery unit
34 control unit
35 cavity
36 airflow path
37 protrusion
4 manufacturing apparatus
41 roller
42 cutter
43 coating unit
44 oven

What is claimed is:

1. A non-combustion-heating-type flavor inhalation article used with an electrical heating type device comprising an inductor for electromagnetic induction heating, the non-combustion-heating-type flavor inhalation article comprising:
a flavor-generating segment that includes a flavor-generating-segment filler containing an aerosol-source material and a plate-shaped susceptor for electromagnetic induction heating of the flavor-generating-segment filler;
a mouthpiece segment for inhaling a flavor component; and
a lining sheet that wraps at least a part of the flavor-generating segment and entire of the mouthpiece segment;
wherein the mouthpiece segment comprises a cooling segment and a filter segment that are arranged downstream side of the flavor-generating segment in an airflow-direction,
the lining sheet is formed of two sheets,
the two sheets are consisting of a first sheet and a second sheet arranged downstream and outer side of the first sheet,
the first sheet wraps entire of the flavor-generating segment and a part of the cooling segment, and the second sheet wraps at least entire of the filter segment and a part of the cooling segment,
a compression change rate of each of the segments, as measured by pressing each airflow-direction central part of the flavor-generating segment and the mouthpiece segment of the non-combustion-heating type flavor inhalation article in accordance with a compression change rate measurement method below, is 70% or greater, where
compression change rate measurement method: a load F of 2 kgf is applied to 10 or 20 samples simultaneously, the 10 or 20 samples being arranged side by side in a horizontal direction, from an upper side to a lower side by using a measuring instrument DD60A manufactured by Borgwaldt Co., Ltd.; after the load F has been applied for 5 seconds, an average of diameters of rod portions is measured; a compression change rate (%) is expressed by a formula below;
compression change rate (%)=100×(Dd (diameter after deformation))/(Ds (diameter before deformation))
where Dd stands for the diameter of each of the rod portions that has been reduced as a result of the load F being applied to the rod portion, and Ds stands for the diameter of each of the rod portions before the load F is applied; in the method, measurement is performed 10 times for each set of 10 or 20 samples, and an average value of results of the measurement performed 10 times is used as a measurement result.

2. The non-combustion-heating-type flavor inhalation article according to claim 1,
wherein the flavor-generating-segment filler comprises at least one selected from tobacco leaves, shredded tobacco, a tobacco sheet, tobacco granules, a nicotine-carrying ion-exchange resin, and a tobacco extract.

3. The non-combustion-heating-type flavor inhalation article according to claim 2,
wherein the flavor-generating-segment filler comprises a tobacco sheet, and the tobacco sheet is inserted in a gathered manner after being crimped.

4. The non-combustion-heating-type flavor inhalation article according to claim 1,
wherein a filling density of the flavor-generating-segment filler in the flavor-generating segment is 0.2 g/cm³ to 0.7 g/cm³.

5. The non-combustion-heating-type flavor inhalation article according to claim 1,
wherein the mouthpiece segment further comprises a filter segment, and the filter segment comprises a filter element and wrapping paper wrapping the filter element, the wrapping paper having a thickness of 40 μm to 100 μm, and a basis weight of 23 gsm to 90 gsm.

6. The non-combustion-heating-type flavor inhalation article according to claim 1,
wherein the mouthpiece segment comprises a cooling segment and a filter segment.

7. The non-combustion-heating-type flavor inhalation article according to claim 5,
wherein the non-combustion-heating-type flavor inhalation article further comprises an end segment and a support segment, and the end segment, the support segment, and the filter segment contain cellulose acetate fibers.

8. The non-combustion-heating-type flavor inhalation article according to claim 7,
wherein the end segment, the support segment, and the filter segment are each a solidified member containing cellulose acetate fibers and a plasticizer.

9. A non-combustion-heating-type flavor inhalation product, the non-combustion-heating-type flavor inhalation product comprising:
the non-combustion-heating-type flavor inhalation article according to claim 1; and
an electrical heating type device,
wherein the electrical heating type device comprises
an inductor for electromagnetic induction heating,
a power source that supplies operation power to the inductor,
a control unit for controlling the inductor, and
a heating chamber into which the non-combustion-heating-type flavor inhalation article can be inserted via an insertion slot.
